(19) United States
(12) Patent Application Publication
(10) Pub. No.: US 2014/0057091 A1
(43) Pub. Date: Feb. 27, 2014

(54) FOAMED ADHESIVE TAPE FOR BONDING TO NON-POLAR SURFACES

(71) Applicant: tesa SE, Hamburg (DE)

(72) Inventors: Thorsten Krawinkel, Hamburg (DE); Alexander Prenzel, Hamburg (DE); Minyoung Bai, Hamburg (DE)

(73) Assignee: tesa SE, Hamburg (DE)

(21) Appl. No.: 13/948,398

(22) Filed: Jul. 23, 2013

(30) Foreign Application Priority Data
Jul. 23, 2012 (DE) 10 2012 212 883.2

(51) Int. Cl. C09J 7/02

(52) U.S. Cl. CPC C09J 7/0246; C09J 7/0289
USPC 428/220; 428/317.3; 428/313.3; 427/208.4

(57) ABSTRACT

An adhesive tape, with a carrier material, has an acrylate-based foam layer bearing at least one layer of pressure-sensitive adhesive. The pressure-sensitive adhesive (a) being composed of a mixture of at least two different synthetic rubbers, more particularly based on vinylaromatic block copolymers, (b) comprising a resin which is not soluble in the acrylates forming the foam layer, and (c) being chemically uncrosslinked.

The present invention relates to a pressure-sensitive adhesive tape consisting of a viscoelastic, acrylate-based foam layer and of at least one layer of pressure-sensitive adhesive (PSA), the PSA layer being composed of a mixture of synthetic rubbers. The invention further encompasses methods for producing and applications of an adhesive tape product of this kind.

Adhesives and adhesive tapes are used in general to assemble two substrates in such a way as to form a lasting or permanent bond. Speciality adhesive tape products have a foam layer and are used, for example, in the automotive industry for the permanent bonding of components to the vehicle body or in the engine compartment. Typical examples of such bonds include emblem bonding and also the fixing of plastics parts and rubber door gaskets.

Examples of pressure-sensitive adhesive tapes of these kinds are disclosed in WO 2008/070386 A1, in U.S. Pat. No. 6,503,621 A and in U.S. Pat. No. 4,415,615 A.

In spite of a multiplicity of adhesives and adhesive tapes, innovative substrates and also heightened requirements with regard to the end-use application make it necessary to develop new pressure-sensitive adhesives, formulations and adhesive-tape designs. It has emerged, for instance, that new developments in the field of automotive paints and varnishes, to which adhesive tapes are to adhere temporarily or permanently, are critical surfaces and pose a challenge to adhesive bonding. On account of the low surface energy of these paints and varnishes, there is a need for adhesive tapes designed especially for these applications.

Furthermore, in view of the ongoing trend in the transport sector and especially in the automotive industry to reduce further the weight of—for instance—a car and thus reduce the fuel consumption, the use of adhesive tapes is on the rise. As a result of this, adhesive tapes are being used for applications for which previous adhesive tape products were neither envisaged nor developed, and, in addition to the mechanical load and the critical substrates for adhesives applications, there are also increasing requirements especially for permanent bonds in respect of UV stability and weathering stability.

Consequently there exists the requirement for an adhesive tape product on the one hand to have enhanced adhesion to low-energy surfaces such as automotive paints and varnishes and on the other hand to preserve an outstanding performance profile even under extreme climatic conditions. Low-temperature impact strength and sufficient cohesion even at high temperatures are required by the automotive industry especially in the case of permanent exterior bonds (emblems, bumpers).

The adhesive tape, additionally, is also required to suit the production operations. In view of ongoing automation of production operations and of the desire for more economical ways of manufacture, the adhesive tape, as soon as it has been positioned at the correct point, is required to exhibit sufficiently high adhesion and in some cases to withstand high shearing forces as well. For these purposes it is of advantage if the adhesive tapes exhibit high tack and the adhesives flow rapidly onto a variety of substrates, so that effective wetting and hence high bond strengths are achieved within a very short time.

Since the last point especially, namely the rapid attainment of constant bond strengths, and hence a low tendency to flow on various surfaces, is difficult to achieve with resin-modified acrylate PSAs or straight acrylic PSAs, often described instead are synthetic rubbers or blends with synthetic rubbers as suitable materials for bonding to non-polar surfaces. EP 0 349 216 A1 and EP 0 352 901 A1 describe two-phase blends consisting of a polyacrylate and a synthetic rubber, preferably a styrene block copolymer, which are praised particularly for their bonding to paints and varnishes. Blend systems, however, may have the disadvantage that the morphology of the blend may alter over time and/or with increasing temperature, as manifested in a macroscopic change in the quality of the polymer and/or product. In extreme cases, moreover, there may be complete separation of the polymer components, and certain blend components may accumulate over time on surfaces, with a possible consequent change in adhesion. Since generally there is great cost and complexity involved—for example, through the use of compatibilizers as disclosed in U.S. Pat. No. 6,379,791 A—in producing blends for adhesive applications that exhibit long-term and thermal stability, these blend systems are not of advantage.

EP 2 226 369 A1 describes an adhesive tape which features a viscoelastic acrylate foam carrier clad with at least one layer of pressure-sensitive adhesive. The pressure-sensitive adhesive is based on a chemically crosslinked rubber, preferably a synthetic rubber crosslinked by means of electron beam curing. The adhesive tapes described there exhibit good bond strengths to various paint and varnish films, and sufficient cohesion at high temperatures. It is nevertheless clearly apparent that these adhesive tapes display a strongly pronounced peel increase, meaning that the high ultimate strengths required are not achieved until after several days. An adhesive tape of that kind, therefore, is unsuitable to rapid production operations.

It is an object of the invention, therefore, to provide an adhesive tape, comprising a carrier material and a PSA applied to at least one side thereof, that exhibits good adhesion to low-energy surfaces such as automotive paints and varnishes, that has low-temperature impact strength, and that exhibits sufficient cohesion even at high temperatures.

This object is achieved by means of an adhesive tape as recorded in the main claim. The dependent claims provide advantageous developments of the subject matter of the invention. Furthermore, the invention encompasses methods for production and also the use of this adhesive tape.

The invention accordingly provides an adhesive tape with a carrier material comprising an acrylate-based, preferably viscoelastic foam layer bearing at least one layer of pressure-sensitive adhesive, the pressure-sensitive adhesive
(a) being composed of a mixture of at least two different synthetic rubbers, more particularly based on vinylaromatic block copolymers;
(b) comprising a resin which is not soluble in the acrylates forming the foam layer; and
(c) being chemically uncrosslinked.

Viscoelasticity is a characteristic materials behaviour in the sense that as well as features of the pure elasticity there are also those of a viscous (viscosity) liquid, as manifested, for example, in the occurrence of internal friction in the course of deformations. In the case of a load which sets in suddenly, such as point pressure exerted on a coating film, for example, viscoelasticity becomes apparent by the deformation occurring only with a certain time delay (retardation=cold flow). In analogy to this, the coating film, even after sudden removal of the load, adopts its original form again only gradually (relaxation). The relaxation behaviour of viscoelastic solid plastics can be measured by means of the creep-recovery test.

The extent of the viscoelasticity is dependent on the temperature, with the glass transition temperature being significant. In the case of a periodic load, another deciding factor for the manner in which the coating material's viscoelasticity is manifested is the frequency. In the case of rapid change, it is the elastic character of the material that is dominant; in the case of slow change, the viscous character predominates.

Surprisingly it has been found that particularly with regard to rapid attainment of the ultimate bonding strength it is a particular advantage to use a chemically uncrosslinked PSA based on a synthetic rubber, more particularly a mixture of vinylaromatic block copolymers, in combination with a viscoelastic acrylate foam carrier. On the other hand, high shear strengths and good temperature resistance can nevertheless be achieved. The adhesive tape of the invention therefore meets each of the requirements described.

The wording “chemically uncrosslinked” is used below for delimitation from a physical or reversible-chemical network, which synthetic rubbers based on a vinylaromatic block copolymer structure are able to form. “Chemically uncrosslinked” means that a covalent-chemical network is explicitly not inventive, but that, on the other hand, a physical and a reversible-chemical network may be encompassed. The covalent-chemical network encompasses all kinds of chemical crosslinking conceivable to the skilled person that are developed with formation of covalent and/or coordinative bonds. Furthermore, chemical crosslinking also encompasses all physical methods which generate chemically reactive groups that then, subsequently, lead to a covalent and/or coordinative bond between two polymer chains, and hence to a covalent-chemical network. Examples of this are electron beam curing and UV crosslinking.

In order to ensure sufficient stability of the adhesives with respect to high temperatures, solvents and other influences, the skilled person is familiar with the application for example of chemical/thermal crosslinking techniques and also of techniques that employ UV radiation or electron beams. These techniques lead to the formation of a covalent crosslinking. Techniques of these kinds are described in EP 2 226 369 A1 or in US 2004/0299000 A1, among other patent texts.

When in the course of the disclosure there is mention of one of the surfaces of the carrier foam bearing an adhesive, more particularly the pressure-sensitive adhesive (PSA) of the invention, the adhesive may be situated directly on the surface. It is in accordance with the invention for one or more chemical adhesion promoter layers (primer layers) to be present between adhesive and foam surface. Adhesion promoters are substances which raise the adhesive strength of assemblies by increasing the wetability of the substrate surface and the possibility for chemical bonds to be formed between the substrate surface and the material to be applied, in this case the PSA. Moreover, it is within the context of the invention for the surface of the layer of adhesive and/or the surface of the foam carrier to be changed by means of a physical pretreatment such as corona, flame or plasma treatment, for example.

Layers other than those specified are excluded in accordance with the invention.

In the context of the invention the term “pressure-sensitive adhesive” (PSA) describes materials (for example elastomers) which either are inherently tacky or by the addition of tackifying resins (“tackifiers”) are formulated in such a way that they are tacky. In accordance with the present invention, PSAs and/or pressure-sensitive adhesive products comprise materials and/or finished products which are classed as PSAs by one of the generally recognized methods for determining such adhesives. References in particular are to those materials and/or finished products which can be classed as PSAs by one or more of the following methods: according to a first method, PSAs are defined by the Dahlquist criteria described in D. Satas, Handbook of Pressure Sensitive Adhesives, 2^{nd} edition, page 172, 1989. In accordance with one of these criteria, a material is defined as a good PSA if at application temperature it has a modulus of elasticity (measured by method H6 elucidated comprehensively later on) of less than 1*10⁶ Pa.

In accordance with the Glossary of Terms Used in the Pressure Sensitive Tape Industry, published in August 1985 by the Pressure Sensitive Tape Council, a PSA is characterized (and can therefore be determined as such) in that at room temperature it has an aggressive and permanent tack and adheres firmly to a multiplicity of different surfaces after mere contact, without further application of any pressure more substantial than being affixed using the finger or using the hand.

Another suitable method for determining PSAs is that they are preferably situated at room temperature (25° C.) within the following storage modulus ranges measured by means of frequency sweep: within a range from 2*10⁵ to 4*10⁵ Pa at a frequency of 0.1 rad/sec (0.017 Hz), and within a modulus range of 2*10⁶ to 8*10⁶ Pa at a frequency of 100 rad/sec (17 Hz) (shown for example in Table 8-16 in D. Satas Handbook of Pressure Sensitive Adhesive Technology, 2^{nd} edition, page 173, 1989).

For the purposes of this invention, the general expression “adhesive tape” encompasses all sheetlike structures such as two-dimensionally extended sheets or sheet sections, tapes with extended length and limited width, tape sections, diecuts, labels and the like. The adhesive tape may be made available in fixed lengths such as, for example, as metre product; in the form of circular rolls (archimedean spirals); or else as “continuous” product on rolls (so-called SAF rolls).

Below, the invention makes comprehensive reference to particular embodiments, but without the invention being confined to these embodiments.

### Viscoelastic Foam Carrier

According to one preferred embodiment, a syntactic foam forms the foam carrier, more particularly the viscoelastic foam carrier. In the case of a syntactic foam, glass beads or hollow ceramic beads (microbeads) or microballoons are bound in a polymer matrix. With a syntactic foam, therefore, the cavities are separate from one another and the substances located within the cavities (gas, air) are separated by a membrane from the surrounding matrix. As a result, the material is substantially stronger than conventional foams with unreinforced gas inclusions.

The viscoelastic foam carriers of the adhesive tape of the invention that are produced by means of the method of the invention, set out later on, may comprise not only the polyacrylate envisaged in accordance with the invention but also all polymers and/or polymer mixtures that are known to the skilled person.

The foam carrier preferably consists only of polyacrylate as scaffold polymer.

The polyacrylate is preferably obtainable by a free or controlled radical polymerization of one or more (meth)acrylic acids or (meth)acrylic esters, and is crosslinked with particular preference thermally, in order—especially in the case of thick foam carrier layers—to prevent a crosslinking gradient, which results inevitably from a photochemical crosslinking method or from electron beam crosslinking.

One preferred variant uses thermally crosslinkable, poly(meth)acrylate-based polymers for the viscoelastic foam carrier layer. The composition advantageously comprises a polymer consisting of
(a1)) 70 to 100 wt % of acrylic esters and/or methacrylic esters and/or the free acids thereof, of the following structural formula

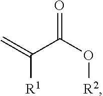

where R¹ is H or CH₃ and R² is H or alkyl chains having 1 to 14 C atoms,
(a2) 0 to 30 wt % of olefinically unsaturated monomers having functional groups, and
(a3) optionally further acrylates and/or methacrylates and/or olefinically unsaturated monomers (preferably with a fraction between 0 to 5 wt %) which are copolymerizable with component (a1) and have a functional group which by means of the coupling reagent leads to covalent crosslinking.

The weight figures are based on the polymer.

Use is made preferably for the monomers (a1)) of acrylic monomers comprising acrylic or methacrylic esters with alkyl groups consisting of 1 to 14 C atoms. Specific examples, without wishing to be confined by this enumeration, are methyl acrylate, methyl methacrylate, ethyl acrylate, ethyl methacrylate, propyl acrylate, propyl methacrylate, n-butyl acrylate, n-butyl methacrylate, n-pentyl acrylate, n-hexyl acrylate, n-hexyl methacrylate, n-heptyl acrylate, n-octyl acrylate, n-nonyl acrylate, lauryl acrylate, stearyl acrylate, stearyl methacrylate, behenyl acrylate and branched isomers thereof such as 2-ethylhexyl acrylate, for example.

Further classes of compound for use that may likewise be added in small amounts under (a1)) are cyclohexyl methacrylates, isonorbonyl acrylate and isobornyl methacrylates.

The fraction thereof is preferably at most up to 20 wt %, more preferably at most up to 15 wt %, based in each case on the total amount of monomers (a1).

Use is made preferably for (a2) of monomers such as, for example, maleic anhydride, itaconic anhydride, glycidyl methacrylate, benzyl acrylate, benzyl methacrylate, phenyl acrylate, phenyl methacrylate, tert-butylphenyl acrylate, tert-butylphenyl methacrylate, phenoxyethyl acrylate, phenoxyethyl methacrylate, 2-butoxyethyl methacrylate, 2-butoxyethyl acrylate, dimethylaminoethyl methacrylate, dimethylaminoethyl acrylate, diethylaminoethyl methacrylate, diethylaminoethyl acrylate and tetrahydrofurfuryl acrylate, this enumeration not being conclusive.

Also preferred for component (a2) is the use of aromatic vinyl compounds, where the aromatic nuclei consist preferably of C₄ to C₁₈ building blocks, and may also contain heteroatoms. Particularly preferred examples are styrene, 4-vinylpyridine, N-vinyl-phthalimide, methylstyrene and 3,4-dimethoxystyrene, this enumeration not being conclusive.

Particularly preferred examples for component (a3) are hydroxyethyl acrylate, 3-hydroxypropyl acrylate, hydroxyethyl methacrylate, 3-hydroxypropyl methacrylate, 4-hydroxybutyl acrylate, 4-hydroxybutyl methacrylate, allyl alcohol, itaconic acid, acrylamide and cyanoethyl methacrylate, cyanoethyl acrylate, 6-hydroxyhexyl methacrylate, N-tert-butylacrylamide, N-methylolmethacrylamide, N-(butoxymethyl)methacrylamide, N-methylolacrylamide, N-(ethoxymethyl)acrylamide, N-isopropylacrylamide, vinylacetic acid, β-acryloyloxypropionic acid, trichloroacrylic acid, fumaric acid, crotonic acid, aconitic acid, dimethylacrylic acid and 4-vinylbenzoic acid, this enumeration not being conclusive.

Monomers of component (a3) may advantageously also be selected such that they include functional groups which support subsequent chemical radiation crosslinking (for example by electron beams or UV). Suitable copolymerizable photoinitiators are, for example, benzoin acrylate and acrylate-functionalized benzophenone derivatives. Monomers which support crosslinking by electron beam bombardment are, for example, tetrahydrofurfuryl acrylate, N-tert-butylacrylamide and allyl acrylate, this enumeration not being conclusive.

For the polymerization the monomers are selected such that the resultant polymers can be employed as thermally crosslinkable polyacrylate compositions, more particularly such that the resultant polymers possess pressure-sensitive adhesive properties in accordance with the Handbook of Pressure Sensitive Adhesive Technology by Donatas Satas (van Nostrand, New York, 1989).

The nature of the comonomers is selected such that the glass transition temperature T_{g,A} of the polymers is below the application temperature, preferably T_{g,A}<=15° C. To achieve this, furthermore, the quantitative composition of the monomer mixture is advantageously selected such that the Fox equation (E1)) (cf. T. G. Fox, Bull. Am. Phys. Soc. 1956, 1, 123) produces the desired T_{g,A} value for the polymer.

$$\frac{1}{{T}_{g}} = {\sum }_{n} \frac{{w}_{n}}{{T}_{g , n}} \qquad ( E1 )$$

In this equation, n represents the serial number of the monomers used, wₙ represents the mass fraction of the respective monomer n (wt %), and T_{g,n} represents the respective glass transition temperature of the homopolymer of the respective monomer n, in K. The determination of these parameters is made in accordance with measurement method A4, elucidated comprehensively later on.

To produce the polyacrylate compositions for the viscoelastic foam carrier, it is advantageous to perform conventional radical polymerizations or controlled radical polymerizations. For the polymerizations proceeding by a radical mechanism it is preferred to use initiator systems which additionally include further radical initiators for the polymerization, more particularly thermally decomposing radical-forming azo or peroxo initiators. In principle, however, all customary initiators familiar to the skilled person for acrylates and/or methacrylates are suitable. The production of C-centred radicals is described in Houben-Weyl, Methoden der Organischen Chemie, Vol. E 19a, pages 60 to 147. These techniques are preferentially employed in analogy.

Examples of radical sources are peroxides, hydroperoxides and azo compounds. A number of non-exclusive examples of typical radical initiators may be given here: potassium peroxodisulphate, dibenzoyl peroxide, cumene hydroperoxide, cyclohexanone peroxide, di-tert-butyl peroxide, azobisisobutyronitrile, cyclohexylsulphonyl acetyl peroxide, diisopropyl percarbonate, tert-butyl peroctoate, and benzopinacol. Particularly preferred for use as radical initiators are 2,2′-azobis(2-methylbutyronitrile) (Vazo® 67 from DuPont), 1,1′-azobis(cyclohexanecarbonitrile) (Vazo® 88) and bis(4-tert-butylcyclohexyl) peroxydicarbonate (Perkadox® 16 from AkzoNobel).

The average molecular weights Mₙ and M_{w} of the carrier layer formed in the radical polymerization are very preferably selected such that they lie within a range from 20 000 to 2 000 000 g/mol; preference is given to producing carrier layers having average molecular weights M_{w} of 200 000 to 1 200 000 g/mol. The average molecular weight is determined via gel permeation chromatography (GPC).

The polymerization may be carried out in bulk, in the presence of one or more organic solvents, in the presence of water, or in mixtures of organic solvents and water. The aim is to minimize the amount of solvent used. Suitable organic solvents are pure alkanes (for example hexane, heptane, octane, isooctane), aromatic hydrocarbons (for example benzene, toluene, xylene), esters (for example ethyl acetate or propyl, butyl or hexyl acetate), halogenated hydrocarbons (for example chlorobenzene), alkanols (for example methanol, ethanol, ethylene glycol, ethylene glycol monomethyl ether), ketones (for example acetone and butanone) and ethers (for example diethyl ether and butyl ether) or mixtures thereof. The aqueous polymerization reactions may be admixed with a water-miscible or hydrophilic co-solvent, in order to ensure that the reaction mixture is in the form of a homogeneous phase during monomer conversion. Co-solvents which can be used with advantage for the present invention are selected from the following group consisting of aliphatic alcohols, glycols, ethers, glycol ethers, pyrrolidines, N-alkyl-pyrrolidinones, N-alkylpyrrolidones, polyethylene glycols, polypropylene glycols, amides, carboxylic acids and salts thereof, esters, organic sulphides, sulphoxides, sulphones, alcohol derivatives, hydroxyether derivatives, amino alcohols, ketones and the like, and also derivatives and mixtures thereof.

The polymerization time—depending on conversion and temperature—is between four and 72 hours. The higher the reaction temperature that can be selected, in other words the higher the thermal stability of the reaction mixture, the lower it is possible to select the reaction time.

For the thermally decomposing initiators, the introduction of heat is essential in order to initiate the polymerization. For the initiators that decompose thermally the polymerization may be initiated by heating to 50 to 160° C., depending on initiator type.

Furthermore, the use of polymerization regulators (chain transfer agents) is likewise advantageous in the sense of the invention, in order thereby to be able to carry out the polymerization in a controlled way and exert an influence over the molar mass distribution.

In this context it is possible for radical stabilization, in a favourable procedure, to use nitroxides, such as, for example, 2,2,5,5-tetramethyl-1-pyrrolidinyloxyl (PROXYL), 2,2,6,6-tetramethyl-1-piperidinyloxyl (TEMPO), derivatives of PROXYL or of TEMPO, and other nitroxides familiar to the skilled person.

A series of further polymerization methods by which the adhesives can be produced in alternative procedures may be selected from the prior art.

WO 96/24620 A1 describes a polymerization process which uses very specific radical compounds such as, for example, phosphorus-containing nitroxides which are based on imidazolidine.

WO 98/44008 A1 discloses specific nitroxyls which are based on morpholines, piperazinones and piperazinediones.

DE 199 49 352 A1 describes heterocyclic alkoxyamines as regulator agents in controlled-growth radical polymerizations.

Another controlled polymerization technique that can be employed advantageously for the synthesis of block copolymers is Atom Transfer Radical Polymerization (ATRP), using as initiator preferably monofunctional or difunctional secondary or tertiary halides and, to abstract the halide or halides, certain metal complexes. The various possibilities of ATRP are further described in the specifications of U.S. Pat. No. 5,945,491 A, of U.S. Pat. No. 5,854,364 A and of U.S. Pat. No. 5,789,487 A.

A very preferred production operation performed is a variant of RAFT polymerization (reversible addition-fragmentation chain transfer polymerization). The polymerization process is described comprehensively for example in specifications WO 98/01478 A1 and WO 99/31144 A1. Suitable with particular advantage for the preparation are trithiocarbonates of the general structure R′″—S—C(S)—S—R′″ (Macromolecules 2000, 33, pages 243 to 245).

In one very advantageous variant, for example, the trithiocarbonates (TTC1) and (TTC2) or the thio compounds (THI1) and (THI2) are used for the polymerization, where φ may be a phenyl ring, which may be unfunctionalized or functionalized by alkyl or aryl substituents, linked directly or via ester or ether bridges, or may be a cyano group or may be a saturated or unsaturated aliphatic radical. The phenyl ring φ may optionally carry one or more polymer blocks, as for example polybutadiene, polyisoprene, polychloroprene or poly(meth)acrylate, which may have a construction as defined for P(A) or P(B), or polystyrene, to name but a few. Functionalizations may be, for example, halogens, hydroxyl groups, epoxide groups, nitrogen-containing or sulphur-containing groups, without this enumeration making any claim to completeness.

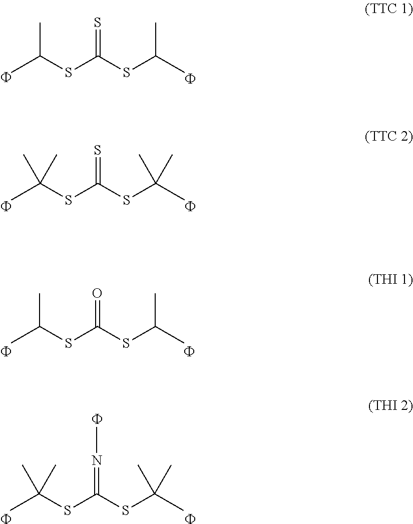

In conjunction with the abovementioned polymerizations that proceed by a controlled-growth radical mechanism, preference is given to initiator systems which further comprise other radical initiators for the polymerization, especially the thermally decomposing radical-forming azo or peroxo initiators already enumerated above. In principle, however, all customary initiators known for acrylates and/or methacrylates are suitable for these purposes. It is also possible, moreover, to use radical sources which liberate radicals only under UV irradiation.

The polyacrylates obtainable by the methods of the invention may be admixed with at least one tackifying resin. In accordance with one advantageous embodiment of the invention, the fraction of resins, based on the overall composition, is between 0 and 40 wt %, advantageously between 20 to 35 wt %. Tackifying resins to be added that can be used are those tackifier resins already known and described in the literature.

Reference may be made more particularly to all aliphatic, aromatic and alkylaromatic hydrocarbon resins, hydrocarbon resins based on pure monomers, hydrogenated hydrocarbon resins, functional hydrocarbon resins, and natural resins. It is possible with preference to employ α-pinene, β-pinene and δ-limonene, indene resins, rosins, their disproportionated, hydrogenated, polymerized and esterified derivatives and salts, terpene resins and terpene-phenolic resins, and also C₅, C₅/C₉, C₉ and other hydrocarbon resins. Combinations of these and further resins as well may be used with advantage in order to bring the properties of the resultant adhesive into line with the requirements. With particular preference it is possible to employ all resins that are compatible (soluble) with the polyacrylate in question. One particularly preferred procedure adds terpene-phenolic resins and/or rosin esters. Aforementioned tackifier resins may be employed both alone and in a mixture.

Optionally it is also possible to use additives such as powderous and granular fillers, dyes and pigments, especially including abrasive and reinforcing products of these kinds, such as, for example, Aerosils (fumed silicas), chalks (CaCo₃), titanium dioxides, zinc oxides and carbon blacks, and it is possible, especially in the case of melt processing, to use them in high proportions as well, of 0.5 to 50 wt %, based on the overall formula. Great preference may be given to using Aerosils and various forms of chalk as filler, with Mikrosöhl chalk being particularly preferred for use. In preferred proportions of up to 30 wt %, there is virtually no change to the adhesives properties (shear strength at RT, instantaneous bond strength to steel and PE) as a result of the addition of filler.

Furthermore, especially in the case of bulk polymerization and of further processing from the polymer melt, it is possible for low-flammability fillers, such as ammonium polyphosphate, for example, and also electrically conductive fillers (such as conductive carbon black, carbon fibres and/or silver-coated beads, for example), and also thermally conductive materials (such as boron nitride, aluminium oxide and silicon carbide, for example), and also ferromagnetic additives (such as iron(III) oxides, for example), and also volume-increasing additives, especially for producing foamed layers and/or syntactic foams (such as blowing agents, solid glass beads, hollow glass beads, carbonized microbeads, hollow phenolic microbeads, microbeads made of other materials, expandable microballoons (Expancel® from AkzoNobel), silica, silicates, renewable organic raw materials, such as sawdust, organic and/or inorganic nanoparticles, and fibres), and also ageing inhibitors, light stabilizers, ozone protectants, compounding agents and/or expandants, to be added or incorporated by compounding. Ageing inhibitors which can be used include preferably not only primary inhibitors, as for example 4-methoxyphenol or Irganox® 1076, but also secondary inhibitors, as for example Irgafos® TNPP or Irgafos® 168 from BASF, also in combination with one another. Reference here will be made only at this point to further, corresponding Irganox® products from BASF and/or Hostanox® from Clariant. Other outstanding agents to counter ageing that may be used include phenothiazine (C-radical scavenger) and also hydroquinone methyl ether in the presence of oxygen, and also oxygen itself.

The expandable polymeric microbeads, also called microballoons, are hollow elastic spheres which have a thermoplastic polymer shell; accordingly they are also referred to as expandable polymeric microspheres. These spheres are filled with low-boiling liquids or liquefied gas. Shell material used includes more particularly polyacrylonitrile, polyvinyl dichloride (PVDC), polyvinyl chloride (PVC), polyamides or polyacrylates. Suitable low-boiling liquid includes, in particular, hydrocarbons of the lower alkanes, such as isobutane or isopentane, for example, which are enclosed in the form of a liquefied gas under pressure in the polymer shell. As a result of exposure of the microballoons, more particularly through heat exposure—in particular by supply of heat or generation of heat, by means of ultrasound or microwave radiation, for example, —on the one hand there is a softening of the external polymer shell. At the same time the propellant liquid gas present within the shell undergoes transition to its gaseous state. With a particular pairing of pressure and temperature, the microballoons undergo an irreversible and three-dimensional expansion. Expansion is at an end when the internal pressure matches the external pressure. Since the polymeric shell is retained, a closed-cell foam is thus produced.

A multiplicity of types of microballoon are available commercially, such as, for example, from Akzo Nobel, the Expancel DU (dry unexpanded) products, which differ substantially in their size (6 to 45 μm diameter in the unexpanded state) and the initiation temperature they require for expansion (75° C. to 220° C.).

Also available, furthermore, are unexpanded microballoon products in the form of an aqueous dispersion with a solids fraction or microballoon fraction of around 40 to 45 wt %, and also polymer-bound microballoons (masterbatches), for example in ethylene-vinyl acetate, with a microballoon concentration of around 65 wt %. Additionally obtainable are what are called microballoon slurry systems, where the microballoons are present with a solids fraction of 60 to 80 wt % as an aqueous dispersion. The microballoon dispersions, the microballoon slurries and the masterbatches, like the DU products, are suitable for foaming in accordance with the advantageous development of the invention.

As a result of their flexible, thermoplastic polymer shell, the foams produced with microballoons possess a greater crack-bridging capability than those filled with non-expandable, non-polymeric hollow microbeads (such as hollow glass or ceramic beads). They are therefore better suited to the compensation of manufacturing tolerances. Furthermore, a foam of this kind is better able to compensate thermal stresses.

Following the polymerization, as a further option, the polyacrylate may also be mixed or blended with other polymers. Suitability for this purpose is possessed by polymers based on natural rubber, synthetic rubber, vinylaromatic block copolymer, for example styrene block copolymers, EVA, silicone rubber, acrylic rubber and polyvinyl ether. The polymer blends are produced either in solution or in an extruder, preferably in a multi-screw extruder or in a planetary roller mixer, in the melt.

An optional possibility is to add the customary plasticizers (plasticizing agents), more particularly in concentrations of up to 5 wt %. Plasticizers used may be low molecular mass polyacrylates, phthalates, water-soluble plasticizers, plasticizing resins, phosphates, polyphosphates, adipates and/or citrates, for example.

The internal strength (cohesion) of the viscoelastic polyacrylate foam carrier is preferably increased by crosslinking. For this purpose it is possible optionally to add compatible crosslinker substances to the acrylate-containing compositions. Examples of suitable crosslinkers include metal chelates, polyfunctional isocyanates, polyfunctional amines, polyfunctional epoxides, polyfunctional aziridines, polyfunctional oxazolines, polyfunctional carbodiimides or polyfunctional alcohols which react with functionalities that are reactive and are present in the polymer. Polyfunctional acrylates as well can be used advantageously as crosslinkers for an actinic irradiation.

The viscoelastic polyacrylate foam carrier layer of the pressure-sensitive adhesive article of the invention has a layer thickness of at least 0.3 mm, preferably of at least 0.5 mm. A typical layer thickness range for such a foam layer is between 0.3 mm up to 5 mm, preferably from 0.5 mm up to 2 mm, even more preferably between 0.5 mm and 1.2 mm. The foam layer has a cellular membrane structure, preferably a closed-cell membrane structure, more preferably a syntactic foam structure, in which 15% to 85% of the volume is occupied by cavities.

The foam carrier of the invention manages even without tackifier resins (K), additives (A), including the aforementioned fillers, plasticizers (W) or additional polymers (P), and also without K+A, K+W, K+P, A+W and the other possible two-way combinations, and additionally without K+A+W, K+A+P and the other possible three-way combinations, or without K+A+W+P.

Further implementation of the method for producing the viscoelastic foam carrier

The viscoelastic foam carrier of the adhesive tape of the invention can be produced from solution or solventlessly from the melt. Processing from the melt is particularly preferred, since the absence of a drying step allows production of foams having particularly thick layers. As described above, thermal crosslinking of the viscoelastic foam is desirable, since it allows a crosslinking gradient to be avoided, in contrast to photochemical crosslinking or to electron beam curing. With particular advantage the thermal crosslinking may be accomplished in line with the thermal methods for crosslinking polyacrylate melts that are specified in EP 0 752 435 A1 and EP 1 978 069 A1, and which are therefore explicitly included in the disclosure content of the present specification. The invention is not confined thereto, however. It is also possible to use all crosslinking techniques that are familiar to the skilled person.

Moreover, processing from the melt is particularly preferred since it allows the foaming operation to be controlled in a targeted way, thereby permitting optimum adjustment of cell structure and also of the density of the foam carrier. The foaming operation may in particular be carried out advantageously in accordance with WO 2010/112346 A1, which is therefore explicitly included in the disclosure content of the present text. The invention, however, is not restricted thereto.

Another very advantageous embodiment of the foaming operation in the present invention is the targeted suppression of foaming in the extrusion operation, that then takes place following departure from a die, through the pressure loss that is generated by such departure.

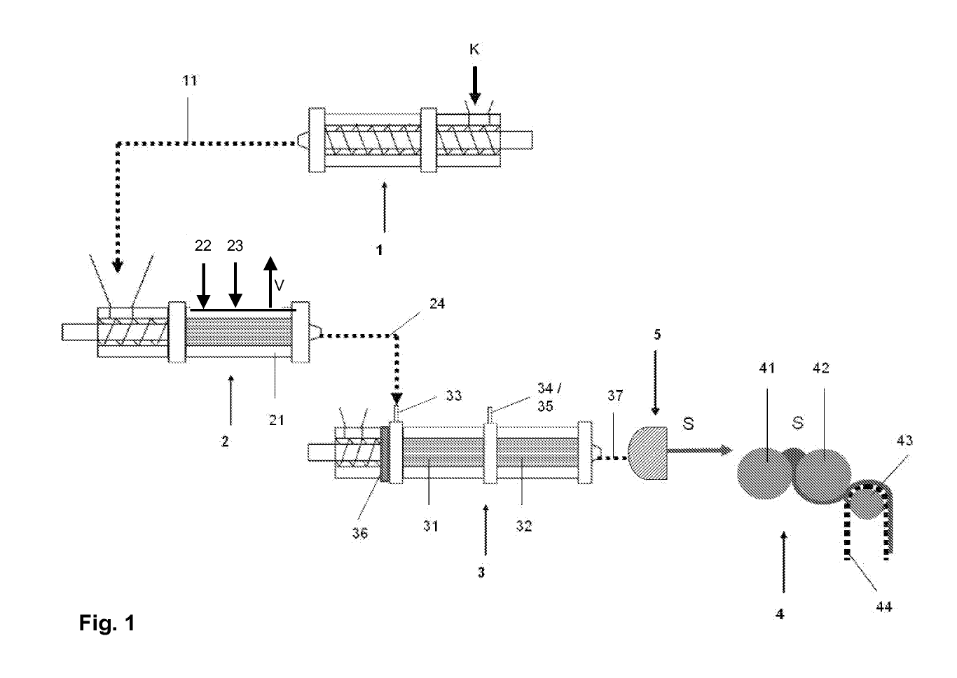

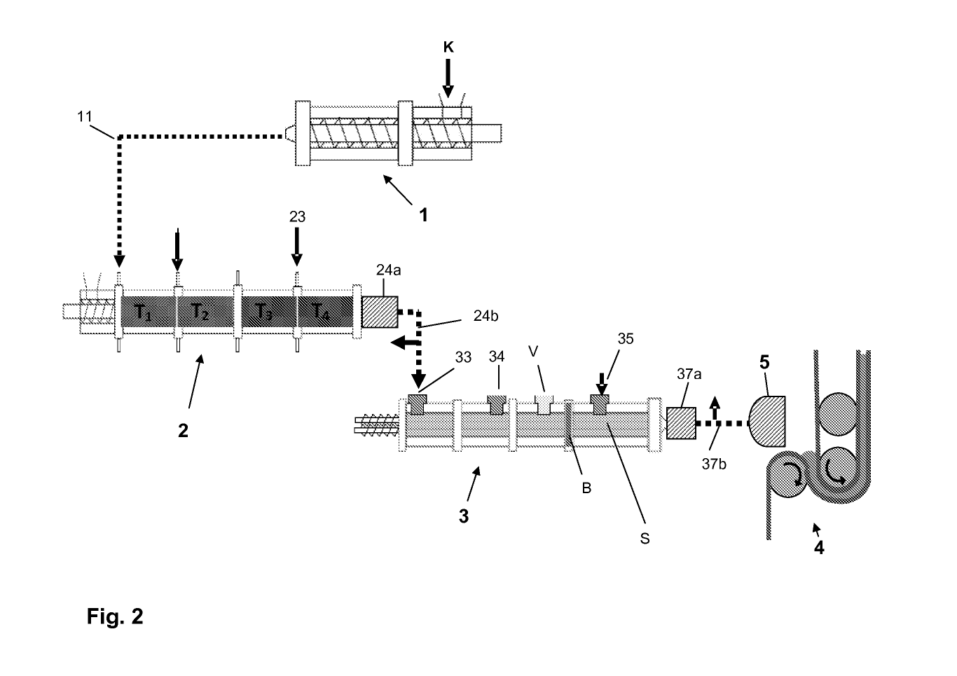

The process for suppression of foaming in the extrusion operation is carried out preferably as follows (cf. FIGS. 1 and 2).

The base polymer K is melted and conveyed, in particular by means of a conveying assembly 1, to a mixing assembly 2. In this assembly 2, and optionally in one or more further mixing assemblies 3 (suitable mixing assemblies 2, 3 are, in particular, extruders, such as twin-screw extruders and/or planetary roller extruders), further necessary components and, where appropriate, optional components are mixed in at particular metering points 22, 23, 34, 35, and 36, such as resins, accelerants, crosslinkers, fillers, and the like, and also the microballoons. If necessary, at least one of the mixing assemblies 2, 3 or a further optionally provided assembly (not shown in the figures) is suitable for degassing the polymer melt. This degassing unit is unnecessary, particularly if all of the mixture constituents have already been degassed prior to addition and the further ingress of gases has been avoided. Advantageously there is a vacuum dome V used for generating the subatmospheric pressure which produces degassing. The addition of the microballoons takes place in particular at elevated pressure, in order to suppress premature expansion of the hollow microbeads at the temperature of the polymer melt.

The melt mixture produced in this way is transferred to a die 5. On departure from the die 5, there is a drop in pressure, and so the hollow microbeads following their departure, in other words following the drop in pressure, undergo expansion and ensure the foaming of the polymer composition. The composition foamed in this way is subsequently shaped, more particularly by means of a roll mill 4, such as a roll calender.

The process of the invention is elucidated in more detail below with reference to two figures, without any intention that the teaching according to the invention should be restricted unnecessarily by this exemplary representation. In the figures

FIG. 1 shows an apparatus construction particularly useful for implementing the process,

and

FIG. 2, superimposed on the apparatus construction dealt with before, shows by way of example a locational assignment of the individual process steps and additionally, in particular, the parameters of temperature and pressure.

The arrangement of the assemblies and process apparatus constituents, especially of the mixing assemblies, is presented by way of example, and can be varied according to the process regime.

### FIG. 1

In a first assembly 1, as for example in a conveying assembly such as an extruder (more particularly a single-screw conveying extruder), the base polymer composition K is melted and is conveyed, in particular by means of this conveying assembly 1, as a polymer melt, via a connecting section 11, more particularly a heatable connecting section 11 (for example, a hose or a pipe), into a second assembly 2, more particularly a mixing assembly such as a twin-screw extruder.

Via one or more metering points 22, 23 in the second assembly, it is possible, jointly or separately from one another, for additives to be added to the base polymer melt, such as, for example, all the resins or some of the resins, the crosslinker system or parts thereof (more particularly crosslinker and/or accelerant), fillers, colour pastes or the like.

Prior to departure from the assembly 2, in other words in particular from the twin-screw extruder, the polymer melt thus blended is degassed, more particularly via a vacuum dome V at a pressure of 175 mbar or less, and subsequently is conveyed via a second connecting section 24, more particularly a heatable connecting section 24 (for example, a hose or a pipe), into a third assembly 3, more particularly a second mixing assembly, as for example a planetary roller extruder provided with a sliding sealing ring 36.

The third assembly 3, more particularly the planetary roller extruder, has one or more temperature-controllable mixing zones 31, 32 and one or more injection or metering facilities 33, 34, 35, for the polymer melt to be introduced and to be blended with further components and/or additives, the latter components and/or additives having more particularly already been degassed.

Via a metering point 34, for example, a resin or a resin mixture is added. Advantageously the resin or resin mixture has been degassed beforehand in a separate vacuum dome V. Via a metering point 35 (here drawn in only schematically at the same point as 34, although it may well be—and usually is—a different metering point situated at a different point on the extruder), the microballoons embedded into a liquid are added. Via the same metering point or a further metering point, not shown in FIG. 1, the crosslinker system or parts thereof (in particular, hitherto absent components of the crosslinker system) may be added. Advantageously, the crosslinker system or parts thereof—more particularly crosslinker and/or accelerant—may be mixed in together with the microballoons, as a microballoon/crosslinker system mixture. In a heating zone 32 (heatable mixing zone), the polymer melt is compounded with the added components and/or additives, but at least with the microballoons.

The resultant melt mixture is transferred via a further connecting section or a further conveying unit 37, such as a gear pump, for example, into a die 5. On departure from the die 5, in other words after a pressure drop, the incorporated microballoons undergo expansion, so giving rise to a foamed polymer composition, more particularly a foamed self-adhesive composition, which is subsequently shaped, being shaped, for example, as a web by means of a roll calender 4 (rolls 41, 42, and 43 of the calender; carrier material 44 onto which the polymer layer is deposited).

### FIG. 2

The base polymer composition K is melted in a first assembly 1, as for example in a conveying assembly such as an extruder (more particularly a single-screw conveying extruder), and with this assembly is conveyed in the form of a polymer melt, via a heatable hose 11 or a similar connecting section (for example, a pipe), into a second assembly 2, as for example a mixing assembly such as a planetary roller extruder. In FIG. 2, by way of example for this, a modular-construction planetary roller extruder is provided which has four modules that can be temperature-controlled independently of one another (T₁, T₂, T₃, T₄.

Via the metering port 22 it is possible for further components to be added, here in particular a melted resin or a melted resin mixture (for better miscibility, it may be advantageous to select a high temperature in the segment T₂, and preferably in the segment T₁ as well). There is also the possibility of supplying additional additives or fillers, such as colour pastes, for example, via further metering ports such as 22 present in the assembly 2 (not drawn in separately). At the metering point 23 it is possible with advantage to add the crosslinker. For this purpose it is advantageous to lower the temperature of the melt, in order to lower the reactivity of the crosslinker and thereby to increase the processing life (temperature in segment T₄ low, advantageously low in the segment T₃ as well).

By means of a heatable hose 24b or a similar connecting section and a melt pump 24a or another conveying unit, the polymer melt is conveyed into a third assembly 3, such as a further mixing assembly, for example, such as a twin-screw extruder, and is fed into this assembly 3 at position 33. At the metering point 34, for example, the accelerant component is added. The design of the twin-screw extruder is advantageously such that it can be used as a degassing apparatus. Thus, for example, at the point shown, the entire mixture can be freed from all gas inclusions in a vacuum dome V at a pressure of 175 mbar or less. After the vacuum zone on the screw there is a blister B (a throttle point in the extrusion chamber, formed in particular as a circulating gap, such as an annular gap, for example, which serves, in particular, for adjusting the pressure of the melt processed in the extruder), which allows a build-up of pressure in the segment S that follows. Through appropriate control of the extruder speed and of the conveying unit downstream of the extruder, such as a melt pump 37a, for example, a pressure of 8 bar or more is built up in the segment S between blister B and melt pump 37a. In this segment S, at a metering point 35, the microballoon mixture (microballoons embedded into a liquid) is introduced, and is incorporated homogeneously into the polymer composition in the extruder.

The resultant melt mixture is transferred by means of the conveying unit (melt pump 37a and a connecting section 37b, such as a hose, for example) into a die 5. On departure from the die 5, in other words after a drop in pressure, the incorporated microballoons undergo expansion, thereby forming a foamed polymer composition, more particularly a foamed carrier layer S, which is subsequently shaped, being shaped, for example, as a web by means of a roll calender 4.

Furthermore, all of the chemical and physical foaming methods familiar to the skilled person may be used, provided that they do not affect the thermal crosslinking of the polyacrylate.

### Synthetic Rubber PSA

At least one principal side of the viscoelastic polyacrylate foam carrier is joined with a PSA layer which comprises a synthetic rubber, more preferably a chemically uncrosslinked mixture of vinylaromatic block copolymers. According to one variant of the invention, one principal side of the viscoelastic polyacrylate foam carrier is provided with a PSA layer of the invention, and the other principal side is provided with another adhesive, more particularly a pressure-sensitive adhesive. In accordance with a further variant of the invention, both principal sides of the viscoelastic polyacrylate foam carrier are each provided with a PSA layer of the invention, although the compositions need not be identical.

The PSA preferably comprises only vinylaromatic block copolymers as scaffold polymer.

The structures of the preferred block copolymers of the invention used as mixtures are selected in accordance with the general formulae I and II.

Accordingly, a PSA of the invention comprises at least 70 wt %, preferably 80 wt %, a mixture of

(i) block copolymers comprising a mixture of block copolymers with the structures I and II
I) A′-B′
II) A-B-A, (A-B)ₙ, (A-B)ₙX and/or (A-B)ₙX, where
   X is the radical of a coupling reagent,
   n is an integer between 2 and 10,
   A and A′ is a polymer block of a vinylaromatic,
   B and B′ is a polymer block formed from butadiene, a mixture of butadiene and isoprene and/or a mixture of butadiene and styrene, and
   A and A′, and B and B′, may be identical or different,
      (ii) at least one tackifier resin,
      the fraction of the block copolymers I) being between 30 and 70 wt %, based on the total amount of block copolymers,
      the fraction A in the case of the block copolymers II) being between 25 and 40 wt %, preferably between 25 and 33 wt %,
      and the A-B unit within at least one of the vinylaromatic block copolymers of the structure II having a molecular weight M_{w} of greater than 65 000 g/mol, the molecular weight M_{w} of the total block copolymer II being greater than 130 000 g/mol.

Preferably all of the A-B units within at least one of the vinylaromatic block copolymers of structure II have a molecular weight M_{w} of greater than 65 000 g/mol.

With further preference all of the A-B units in all the vinylaromatic block copolymers of structure II have a molecular weight M_{w} of greater than 65 000 g/mol.

In accordance with one advantageous embodiment of the invention, the only elastomers included in the PSA are a mixture of vinylaromatic block copolymers of structures I and II.

The mixture may consist of precisely one vinylaromatic block copolymer of structure I and precisely one vinylaromatic block copolymer of structure II.

In an alternative embodiment of the invention, the mixture comprises a plurality of different vinylaromatic block copolymers of structure I and/or of structure II, preferably at the same time two or more different vinylaromatic block copolymers of structure I and of structure II.

According to a further preferred embodiment of the invention, the fraction of the vinylaromatic block copolymer or of the vinylaromatic block copolymers of structure I in the sum total of the vinylaromatic block copolymers of structures I and II is between 50 and 65 wt %.

According to a further preferred embodiment of the invention the fraction or fractions of the vinylaromatic end block A′ in the block copolymer of structure I is or are between 20 and 40 wt %, preferably between 25 and 33 wt %.

In a variant of the invention the fraction or fractions of the vinylaromatic end block A′ in the block copolymer of structure I is or are between 13 and 20 wt %.

As vinylaromatics A and/or A′ within the vinylaromatic block copolymers it is possible for example to use styrene, vinyltoluene, α-methylstyrene, chlorostyrene, o- or p-methylstyrene, 2,5-dimethylstyrene, p-methoxystyrene and p-tert-butylstyrene.

The polymer B and/or B′ may be formed from butadiene alone or in a mixture with isoprene or styrene. Both block structures and randomly distributed monomers are possible here.

Customary coupling reagents for the production of diblock, triblock, multi-block and star block copolymers are known to the skilled person. To name but a few, examples include 2-vinylpyridine, 1,4-di(bromomethyl)benzene, dichlorodimethylsilane or 1,2-bis-(trichlorosilyl)ethane, without the coupling reagents being confined to these. Of these coupling reagents, X remains as a residue after coupling.

A suitable vinylaromatic block copolymer comprises one or more rubberlike blocks B and/or B′ (soft blocks) and one or more glasslike blocks A and/or A′. Below, when A and B are mentioned, the reference is always to A′ and B′ as well. In certain embodiments the block copolymer comprises at least one glasslike block. In certain other embodiments according to the invention, the block copolymer comprises between one and five glasslike blocks.

In certain advantageous embodiments, in addition to the structures I and II, a block copolymer is used as well that is a multi-arm block copolymer. This copolymer is described by the general formula Qₙ-Y, in which Q represents an arm of the multi-arm block copolymer and n in turn represents the number of arms with n being an integer of at least 3. Y is the residue of a multi-function coupling reagent. Each arm Q has independently the formula A-B, in which, in analogy to the structures I and II, A represents the glasslike block and B the soft block.

The block A is generally a glasslike block with a glass transition temperature (T_{g}) which is above the room temperature. In certain advantageous embodiments the T_{g} of the glasslike block is at least 40° C., preferably at least 60° C., more preferably at least 80° C. or very preferably at least 100° C.

The vinylaromatic block copolymer, furthermore, generally has a rubberlike block B, or soft block, having a T_{g} of less than room temperature. In certain embodiments the T_{g} of the soft block is less than 0° C. or even is less than −10° C. In other advantageous embodiments the T_{g} of the soft block is less than −40° C. or more preferably less than −60° C.

Besides the inventive and particularly preferred monomers for the soft block B, stated for the formulae I and II, further advantageous embodiments comprise a polymerized conjugated diene, a hydrogenated derivative of a polymerized conjugated diene, or a combination thereof. In certain embodiments the conjugated dienes comprise 4 to 12 carbon atoms. Additional examples of other advantageous conjugated dienes for the rubberlike block B include ethylbutadiene, phenylbutadiene, piperylene, pentadiene, hexadiene, ethylhexadiene and dimethylbutadiene, and the polymerized conjugated dienes may be present in homopolymer or copolymer form.

In another particular embodiment, in addition to the mixture of the linear block copolymers of structure I and/or II, there are also one or more of the aforementioned and above-described multi-arm block copolymers used. By this means, and also through the use of end block reinforcers such as α-methylstyrene resins, for example, the shear strength of the chemically uncrosslinked PSA of the invention can be increased without construction of a chemical covalent network. The cohesion of the composition can be increased without at the same time adversely affecting the flow behaviour, as would inevitably occur in the event of crosslinking, as already described above. Advantageous embodiments feature a ratio of the linear block copolymers to the multi-arm block copolymers of 1.5:1 to 9:1.

Besides the at least one vinylaromatic block copolymer, the pressure-sensitive adhesive has at least one tackifier resin in order to increase desirably the adhesion. The tackifier resin ought to be compatible with the elastomer block (soft block) of the block copolymers. Suitable tackifier resins include preferably unhydrogenated, partially hydrogenated or fully hydrogenated resins based on rosin or rosin derivatives. Ideally the tackifier resin is not compatible with the acrylate polymers of the viscoelastic polyacrylate foam carrier. Suitable tackifier resins include preferably hydrogenated polymers of dicyclopentadiene, unhydrogenated or partially, selectively or fully hydrogenated hydrocarbon resins based on C₅, C₅/C₉ and/or C₉ monomer streams, or, with particular preference, polyterpene resins based on α-pinene and/or β-pinene and/or δ-limonene. Aforesaid tackifier resins may be used either alone or in a mixture. Moreover, the adhesive formulation may also include tackifier resins which are liquid at room temperature.

A further-preferred embodiment comprises a first resin of high T_{g}, having a glass transition temperature of at least 60° C. The “high glass transition temperature”, and “resin of high T_{g}” phrases used in this context relate in this context to resins having a glass transition temperature of least 60° C. In other preferred embodiments the first resin of high T_{g} possesses a glass transition temperature of at least 65° C. or even at least 70° C. In another preferred embodiment the first, high-T_{g} resin has a softening point of at least 115° C., and in further embodiments of at least 120° C.

This adhesive resin is more particularly compatible with the elastomer blocks of the block copolymers.

Another preferred embodiment of the PSA layer further comprises a second resin of high T_{g}, which is arbitrarily compatible primarily with the glasslike blocks of the linear block copolymers and/or of the multi-arm block copolymers. Primarily compatible here means that it is compatible in any event with the glasslike block and possibly with the elastomer block.

Further embodiments of the PSA layer further comprise at least one additional component selected from the group of resins of low glass transition temperature, plasticizers, or combinations thereof. Resins of low T_{g} for the purposes of this invention are resins which exhibit a T_{g} of less than 60° C.

Particularly preferred is a ratio of the elastomer block-compatible resin of high T_{g} to the resin of high T_{g} that is more compatible with the glasslike block of 1:1 to 19:1.

Further additives which can typically be utilized are as follows:
primary antioxidants, such as, for example, sterically hindered phenols
secondary antioxidants, such as, for example, phosphites or thioethers
in-process stabilizers, such as, for example, C radical scavengers
light-stabilizers, such as, for example, UV absorbers or sterically hindered amines
processing assistants
in general, ageing inhibitors
optionally further polymers of preferably elastomeric kind; elastomers utilizable accordingly include among others those based on pure hydrocarbons, for example unsaturated polydienes, such as natural or synthetically generated polyisoprene or polybutadiene, elastomers with substantial chemical saturation, such as, for example, saturated ethylene-propylene copolymers, α-olefin copolymers, polyisobutylene, butyl rubber, ethylene-propylene rubber and also chemically functionalized hydrocarbons, such as, for example, halogen-containing, acrylate-containing or vinyl ether-containing polyolefins, to name but a few.

The shaping of the PSA formulation on at least one side of the viscoelastic polyacrylate foam carrier to form the PSA layer may take place by means of any of the methods familiar to the skilled person. For example, the block copolymers, the suitable resins and further additions such as plasticizers and ageing inhibitors can be dissolved in a suitable solvent and then coated on a release liner (release material) or directly on the viscoelastic polyacrylate foam carrier by conventional methods, which include, among others, knife coating, roll coating, gravure coating, rod coating, casting, spray-coating and airbrush-coating methods. Likewise in the sense of the invention is the substantially solvent-free production and coating of the PSA formulation for the purpose of shaping a PSA layer on the viscoelastic polyacrylate foam carrier, this means essentially that the formulation contains less than 20%, preferably less than 10%, more preferably less than 1% and very preferably less than 0.1% of solvent. Substantially solvent-free methods of this kind include among others that of compounding by means of calendering, roll mills and extrusion (for example single-screw, twin-screw and planetary roller extruders). For the batchwise processing of the PSA formulation, commercial internal mixers such as Brabender or Banbury are suitable. After being compounded, the PSA is preferably coated through a shape-imparting die, in which case coating may take place directly on the foam carrier or on a release material, with subsequent lamination to a foam carrier.

The PSA of the invention may also be without additives (A), including the aforementioned fillers, or without plasticizers (W) or additional polymers (P), and may also be without A+W, A+P and the other possible two-way combinations, and additionally without A+W+P as well.

The PSA layer is advantageously applied at a weight per unit area of 40 to 100 g/m² on the viscoelastic foam carrier layer of the pressure-sensitive adhesive article of the invention.

In one advantageous embodiment of the pressure-sensitive adhesive article of the invention, more particularly a pressure-sensitive adhesive tape article, both sides of the viscoelastic polyacrylate foam carrier are joined with the synthetic rubber PSA of the invention, more particularly a chemically uncrosslinked PSA comprising a mixture of vinylaromatic block copolymers.

In another preferred embodiment the foam carrier is joined only on one side to the synthetic rubber PSA of the invention. In this case the other side of the foam carrier, remote from the PSA, may not have any further PSA layer or may have a different kind of coating, since—likewise in the sense of the invention—the viscoelastic polyacrylate foam carrier per se has the characteristics and properties of a PSA. Moreover, this side may in one alternative embodiment have a further PSA layer, in which case it is possible to use any conventional PSA based on polyacrylates, silicones, polyurethane, natural rubber, poly-α-olefins and other base materials familiar to the skilled person.

In a further preferred embodiment, this remote side of the foam carrier may comprise a heat-activatable layer of adhesive. A heat-activatable layer of adhesive means a layer of adhesive which achieves the maximum achievable bond strength to a substrate only by heating, in which case the heat-activatable adhesive may, but need not, be pressure-sensitively adhesive at room temperature. For the purposes of this invention, for producing a heat-activatable layer of adhesive of this kind, preference is given to using thermoplastics such as, for example, a copolymer based on ethylene and propylene, or a thermoplastic polyurethane, which may additionally be blended with resins.

For transport, storage or punching, the adhesive tape is preferably provided on at least one side with a liner, in other words, for example, with a silicone-coated film or silicone paper.

Further details, objectives, features and advantages of the present invention will be elucidated in more detail below with reference to a number of figures which represent preferred, exemplary embodiments. In these figures

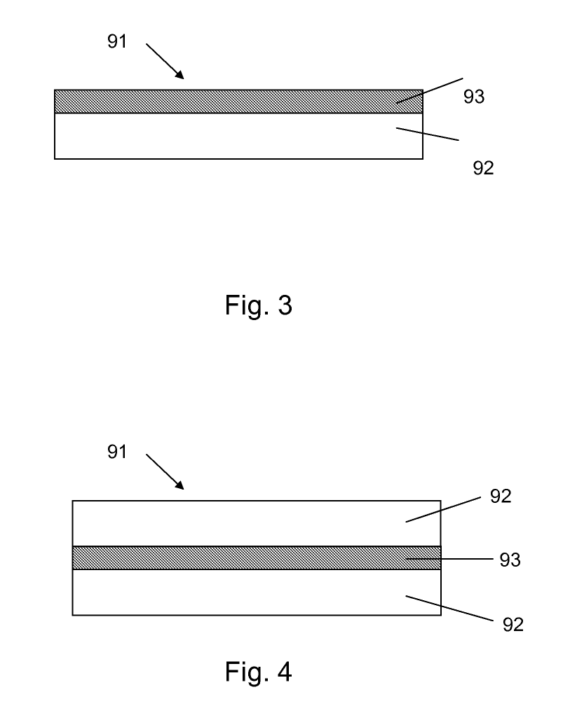

FIG. 3 shows a single-sided pressure-sensitive adhesive tape and

FIG. 4 shows a double-sided pressure-sensitive adhesive tape.

FIG. 3 shows a single-sided pressure-sensitive adhesive tape 91. The tape 91 has an adhesive layer 92 which has been produced by application of one of the above-described PSAs to a carrier 93. The PSA coatweight is preferably between 40 and 100 g/m².

Additionally (not shown) it is also possible to provide a release film which lines and protects the adhesive layer 92 prior to the use of the pressure-sensitive adhesive tape 91. In that case the release film is removed from the adhesive layer 92 before use.

The product construction depicted in FIG. 4 shows a pressure-sensitive adhesive tape 1 having a carrier 93 which is coated on both sides with a PSA and thus has two adhesive layers 92. The PSA coatweight per side is again preferably between 40 and 100 g/m².

In this embodiment as well, preferably at least one adhesive layer 92 is lined with a release film. In the case of a rolled-up adhesive tape, this one release film may optionally also line the second adhesive layer 92. It is also possible, however, for a plurality of release films to be provided.

A further possibility is for the carrier layer to be provided with one or more coatings. Furthermore, only one side of the pressure-sensitive adhesive tape may be equipped with the inventive PSA, and on the other side a different PSA may be used.

As alternatives to release films it is also possible, for example, to use release papers or the like. In that case, however, the surface roughness of the release paper ought to be reduced, in order to produce an extremely smooth PSA side.

In an additional aspect of the invention, a method for producing a pressure-sensitive adhesive product of this kind is claimed, comprising:
(i) producing a viscoelastic foam carrier layer having a top face and a bottom face, by
   (a) providing a mixture which is polymerizable by means of free or controlled radical polymerization and comprises one or more acrylate and alkylacrylate monomers,
   (b) polymerizing the mixture specified under a),
   (c) carrying out thermal crosslinking, and
   (d) foaming the polyacrylate, and
(ii) application by coating of one or more pressure-sensitive adhesives, of which at least one in accordance with the invention
   (a) is chemically uncrosslinked and
   (b) comprises a mixture of synthetic rubbers,
   to at least one of the principal sides of said acrylate foam carrier, in order thus to produce a layer of pressure-sensitive adhesive.

Another particularly advantageous method for producing a pressure-sensitive adhesive product of this kind comprises:
(i) producing a viscoelastic foam carrier layer having a top face and a bottom face, by
   (a) providing a mixture which is polymerizable by means of free or controlled radical polymerization and comprises one or more acrylate and alkylacrylate monomers,
   (b) polymerizing the mixture specified under a),
   (c) removing the solvent,
   (d) processing the polyacrylate in the melt
   (e) in said melt, compounding and homogenizing chemical and/or physical blowing agents and thermal crosslinkers in an extruder,
   (f) carrying out thermal crosslinking, and
   (g) foaming the polyacrylate, and
(ii) application by coating of one or more pressure-sensitive adhesives, of which at least one in accordance with the invention
   (a) is chemically uncrosslinked and
   (b) comprises a mixture of vinylaromatic block copolymers, and also
   (c) comprises resins which are not soluble in a polyacrylate and therefore are unable to migrate into the acrylate foam carrier layer,
   to at least one of the principal sides of said acrylate foam carrier, in order thus to produce a layer of pressure-sensitive adhesive.

Preferred adhesive tape thicknesses are 100 μm to 5000 mm, preferably 250 μm to 4000 μm and more preferably 500 to 3000 μm.

### Advantageous Applications

It has emerged that the adhesive tapes of the invention which comprise a thermally crosslinked viscoelastic acrylate foam carrier and at least one chemically uncrosslinked synthetic rubber composition joined directly to the foam carrier have generally good to excellent adhesive properties and, furthermore, achieve virtually the maximum bond strengths within a very short time, which for the purposes of the present disclosure means a time period of less than 10 minutes. Moreover, they also exhibit good properties on non-polar substrates (see Measurement of 90° bond strength) and also under dynamic and static shearing load, and very good ageing stability.

The adhesive tape of the invention is therefore outstandingly suitable for bonding to non-polar surfaces, but also displays good to very good properties on all other substrates. By non-polar surfaces are meant substrates having a low surface energy or low surface tension, more particularly having a surface tension of less than 45 mN/m, preferably of less than 40 mN/m and more preferably of less than 35 mN/m. For the purpose of determining the surface tension it is possible to measure the contact angle using a goniometer, or to measure the contact angle in accordance with DIN EN 828.

The adhesive products of the invention are suitable especially for the permanent and/or temporary bonding of different materials and components such as, for example, emblems, plastics mouldings (for example bumpers) and rubber gaskets on the body of a motor vehicle, more particularly of a car. In one embodiment, for example, the adhesive tape article may be bonded to the body of a car by means of the chemically uncrosslinked synthetic rubber PSA layer, and thereafter a plastics moulding, plastics emblem or the like may be joined or bonded to the other side of the adhesive tape article, the other side having a PSA layer, a heat-activatable adhesive layer or no layer at all. Typically the emblem, the plastics moulding or the gasket is first bonded with the adhesive tape, and the resulting assembly can subsequently be connected to a motor vehicle, more particularly to a car.

In the case of bonding of rubber gaskets, more particularly EPDM rubber profiles, it is especially advantageous if the side with the chemically uncrosslinked PSA layer of the invention is bonded to the body and if the foam carrier on the other side has a heat-activatable adhesive layer which, following activation, is connected to the rubber gasket. The direct bonding of the rubber gasket on the foam carrier may likewise be preferable.

The assembly described in the previous paragraph, of the adhesive tape articles with the rubber gasket, can easily be joined to a car door and employed in that form as a door seal.

In the text below, the invention is illustrated in more detail with reference to an example, without thereby restricting the invention.

### EXPERIMENTAL SECTION

The exemplary experiments below are intended to illustrate the invention in more detail, without any intention that the choice of the examples indicated should unnecessarily restrict the invention.

### Measurement Methods (General):

### K Value (According to Fikentscher) (Method A1):

The K value is a measure of the average molecule size in high-polymer compounds. For the measurement, one percent strength (1 g/100 mL) toluenic polymer solutions were prepared, and their kinematic viscosities were determined using a Vogel-Ossag viscometer. Following standardization to the viscosity of toluene, the relative viscosity is obtained, and can be used to calculate the K value according to Fikentscher (Polymer 1967, 8, 381 ff.)

### Gel Permeation Chromatography GPC (Method A2):

The figures in this specification for the weight-average molecular weight M_{w}, the number-average molecular weight Mₙ and the polydispersity PD relate to the determination by gel permeation chromatography. The determination takes place on 100 μL samples subjected to clarifying filtration (sample concentration 4 g/L). The eluent used is tetrahydrofuran with 0.1 vol % of trifluoroacetic acid. Measurement takes place at 25° C. The preliminary column used is a PSS-SDV column, 5μ, 10³ ç, ID 8.0 mm×50 mm. Separation takes place using the columns PSS-SDV, 5μ, 10³ ç and also 10⁵ ç and 10⁶ Å, each of ID 8.0 mm×300 mm (columns from Polymer Standards Service; detection using Shodex RI71 differential refractometer). The flow rate is 1.0 mL per minute. Calibration takes place against PMMA standards (polymethyl methacrylate calibration).

### Solids Content (Method A3):

The solids content is a measure of the fraction of unevaporable constituents in a polymer solution. It is determined gravimetrically, with the solution being weighed, then the vaporizable fractions being evaporated off in a drying cabinet at 120° C. for 2 hours, and the residue weighed again.

### Static Glass Transition Temperature T_{g} or T_{gA} (Method A4):

The static glass transition temperature is determined by dynamic scanning calorimetry in accordance with DIN 53765. The figures given for the glass transition temperature T_{g} or T_{gA} relate to the glass transformation temperature value T_{g} according to DIN 53765:1994-03, unless indicated otherwise specifically.

### Density Determination by Pycnometer (Method A5a);

The principle of the measurement is based on the displacement of the liquid located within the pycnometer. First, the empty pycnometer or the pycnometer filled with liquid is weighed, and then the body to be measured is placed into the vessel. The density of the body is calculated from the differences in weight:

### Let

m₀ be the mass of the empty pycnometer,
m₁ be the mass of the pycnometer filled with water,
m₂ be the mass of the pycnometer with the solid body,
m₃ be the mass of the pycnometer with the solid body, filled up with water,
ρ_{w} be the density of the water at the corresponding temperature,
ρ_{F} be the density of the solid body.

The density of the solid body is then given by:

$${ρ}_{F} = \frac{( {m}_{2} - {m}_{0} )}{( {m}_{1} - {m}_{0} ) - ( {m}_{3} - {m}_{2} )} \cdot {ρ}_{W}$$

One triplicate determination is carried out for each specimen. It should be noted that this method gives the unadjusted density (in the case of porous solid bodies, in the present case a foam, the density based on the volume including the pore spaces).

Quick Method for Density Determination from the Coatweight and the Film Thickness (Method A5b):

The weight per unit volume or density ρ of a coated self-adhesive composition is determined via the ratio of the weight per unit area to the respective film thickness:

$$ρ = \frac{m}{V} = \frac{MA}{d} \\ [ ρ ] = \frac{[ kg ]}{[ {m}^{2} ] \cdot [ m ]} = [ \frac{kg}{{m}^{3}} ]$$

MA=coatweight/weight per unit area (excluding liner weight) in [kg/m²]
d=film thickness (excluding liner thickness) in [m]

This method as well gives the unadjusted density.

This density determination is suitable in particular for determining the total density of finished products, including multi-layer products.

### Measurement Methods (PSAs Especially):

### 180° Bond Strength Test (Method H1):

A strip 20 mm wide of an inventive adhesive tape was applied to steel plates which beforehand had been washed twice with acetone and once with isopropanol. The pressure-sensitive adhesive strip was pressed onto the substrate twice with an applied pressure corresponding to a weight of 2 kg. The adhesive tape was then immediately removed from the substrate with a velocity of 300 mm/min and at an angle of 180°. All measurements were conducted at room temperature.

The results are reported in N/cm and have been averaged from three measurements. In the same way, determinations were made of the bond strength to polyethylene (PE) and varnish. The varnish used—for examples measured by Method H2 as well—in each case was the Uregloss® colourless varnish (product no. FF79-0060 0900) from BASF.

### 90° Bond Strength to Steel—Open and Lined Sides (Method H2):

The bond strength to steel is determined under test conditions of 23° C.+/−1° C. temperature and 50%+/−5% relative atmospheric humidity. The specimens were cut to a width of 20 mm and adhered to a steel plate. Prior to the measurement, the steel plate is cleaned and conditioned. This is done by first wiping the plate with acetone and then leaving it to lie in the air for 5 minutes so that the solvent can evaporate. The side of the three-layer assembly facing away from the test substrate was then lined with a 50 μm aluminium foil, to prevent the specimen stretching in the course of the measurement. After that, the test specimen was rolled onto the steel substrate. For this purpose, a 2 kg roller was passed five times back and forth over the tape with a rolling speed of 10 m/min. Immediately after rolling, the steel plate was inserted into a special mount which allows the specimen to be peeled off vertically upwards at an angle of 90°. Bond strength measurement was carried out using a tensile tester from Zwick. When the lined side is applied to the steel plate, the open side of the three-layer assembly is first laminated to the 50 μm aluminium foil, the release material is removed and the assembly is adhered to the steel plate, rolled analogously, and subjected to measurement.

The results of measurement for both sides, open and lined, are reported in N/cm and have been averaged from three measurements.

### Holding Power (PSA on PET Film, Method H3):

A strip of the adhesive tape 13 mm wide and more than 20 mm long (30 mm for example) was applied to a smooth steel surface which had been cleaned three times with acetone and once with isopropanol. The bonding area was 20 mm×13 mm (length×width), with the adhesive tape overhanging the test plate (for example by 10 mm in accordance with above-stated length of 30 mm). The adhesive tape was then pressed onto the steel support four times with an applied pressure corresponding to a weight of 2 kg. This sample was suspended vertically, so that the projecting end of the adhesive tape points downwards.

At room temperature a weight of 1 kg was affixed to the projecting end of the adhesive tape. Measurement is conducted under standard conditions (23° C.+/−1° C., 55%+/−5% atmospheric humidity) and at 70° C. in a heating cabinet, the sample being loaded with a weight of 0.5 kg for this measurement.

The holding powers measured (times which elapse before complete detachment of the adhesive tape from the substrate; measurement discontinued after 10,000 minutes) are reported in minutes and correspond to the average of three measurements.

### Holding Power—Open and Lined Sides (Adhesive Tape Articles, Method H4):

Preparation of specimens was carried out under test conditions of 23° C.+/−1° C. temperature and 50%+/−5% relative atmospheric humidity. The test specimen was cut to 13 mm and adhered to a steel plate. The bonding area is 20 mm×13 mm (length×width). Prior to the measurement the steel plate was cleaned and conditioned. This is done by first wiping the plate with acetone and then leaving it to lie in the air for 5 minutes to allow the solvent to evaporate. After bonding had been performed, the open side was reinforced with a 50 μm aluminium foil and a 2 kg roller was passed twice back and forth over the assembly. A belt loop was then placed on the projecting end of the three-layer assembly. The system was then suspended from a suitable apparatus and subjected to a load of 10 N. The suspension apparatus is of a type such that the weight subjects the sample to load at an angle of 179°+/−1°. This ensures that the three-layer assembly cannot peel from the bottom edge of the plate. The holding power measured, the time between the specimen being suspended and its fall, is reported in minutes and corresponds to the average from three measurements. For the measurement of the lined side, the open side is first reinforced with the 50 μm aluminium foil, the release material is removed, and the specimen is adhered to the test plate in analogy to the description. The measurement is conducted under standard conditions (23° C., 55% humidity).

### Dynamic Shear Strength (Method H5)

A square adhesive tape with an edge length of 25 mm, provided on both sides with the same adhesive, is bonded between two steel plates and pressed down for 1 minute at 0.9 kN (force P). After a storage time of 24 hours, the assembly is parted in a tensile testing machine from Zwick at 50 mm/min and at 23° C. and 50% relative humidity in such a way that the two steel plates are pulled apart from one another at an angle of 180°. The maximum force is determined in N/cm².

### Dynamic Mechanical Analysis (DMA) (Method H6):

Like the parameters of storage modulus (G′) and loss modulus (G″), the complex viscosity can be determined by means of dynamic mechanical analysis (DMA). The measurements can be carried out using a shear stress controlled rheometer (DSR 200 N from Rheometric Scientific) in an oscillation test with a sinusoidally oscillating shearing stress in a plate/plate arrangement. The complex viscosity η* is defined as follows: η*=G*/ω

G*=complex shear modulus, ω=angular frequency.

The further definitions are as follows: G*=√(G′)²+(G″)²

(G″=viscosity modulus (loss modulus), G′=elasticity modulus (storage modulus)).

G″=τ/γ·sin(δ)(τ=shear stress, γ=deformation, δ=phase angle=phase shift between shear stress vector and deformation vector).

G′=τ/γ·cos(δ)(τ=shear stress, γ=deformation, δ=phase angle=phase shift between shear stress vector and deformation vector).
ω=2π·f (f=frequency).

### Commercially Available Chemicals Used

| Chemical compound | Trade name | Manufacturer | CAS No. |
|---|---|---|---|
| SBS (76 wt % diblock, block | Kraton ® D 1118 E | Kraton Polymers | 9003-55-8 |
| polystyrene content: 31 wt %) | | | |
| SBS (16 wt % diblock, block | Kraton ® D 1101 | Kraton Polymers | 9903-55-8 |
| polystyrene content: 31 wt %) | | | |
| SB (100 wt % diblock, block | Solprene ® 1205 | Dynasol | 9903-55-8 |
| polystyrene content: 18 wt %) | | | |
| Hydrocarbon resin (C₅- and C₉- | Escorex ™ 2203 | Exxon Mobil | 64742-16-1 |
| based with small aromatic fraction, | | | |
| (softening point (ring & ball) 95° C.) | | | |
| α-Pinene resin (softening | Dercolyte A 115 | DRT | 25766-18-1 |
| temperature: 115° C.) | | | |
| Liquid hydrocarbon resin (C₅-based) | Wingtack ® 10 | Cray Valley | 26813-14-9 |
| Naphthenic oil | Shellflex ® 371 | Shell | 64742-2-5 |
| 2,2′-Azobis(isobutyronitrile) (AIBN) | Vazo ® 64 | DuPont | 78-67-1 |
| Bis-(4-tert-butylcyclohexyl) | Perkadox ® 16 | Akzo Nobel | 15520-11-3 |
| peroxydicarbonate | | | |
| 3,4-Epoxycyclohexylmethyl | Uvacure ® 1500 | Cytec Industries Inc. | 2386-87-0 |
| 3,4-epoxycyclohexanecarboxylate | | | |
| 2,2′-Azobis(2-methylbutyronitrile) | Vazo ® 67 | DuPont | 13472-08-7 |
| Polyacrylate, resin-modified | Aroset ™ PS 5145 | Ashland | — |
| Resorcinol bis(diphenyl phosphate) | Reofos ® RDP | Chemtura | 57583-54-7 |
| Pentaerythritol tetraglycidyl ether | Polypox ® R16 | UPPC AG | 3126-63-4 |
| N,N,N′-Trimethyl-N′-hydroxyethyl | Jeffcat ® ZF-10 | Huntsman | 83016-70-0 |
| bisaminoethyl ether | | | |
| Triethylenetetramine | Epikure 925 | Hexion Speciality | 112-24-3 |
| | | Chemicals | |
| N′-(3-(dimethylamino)propyl)-N,N- | Jeffcat ® Z-130 | Huntsman | 6711-48-4 |
| dimethyl-1,3-propanediamine | | | |
| Terpene-phenolic resin (softening | Dertophene ® | DRT resins | 25359-84-6 |
| point 110° C.; M_{w} = 500 to 800 g/mol; | T110 | | |
| D = 1.50) | | | |
| Microballoons (MB) | Expancel ® 051 | Expancel Nobel | |
| (dry-unexpanded microspheres, | DU | Industries | |
| diameter 9 to 15 μm, expansion | | | |
| onset temperature 106 to 111° C., | | | |
| TMA density ≦ 25 kg/m³) | | | |

All specification figures at 20° C.;
Epikure ® also sold under the commercial designations Epi-Cure ® and Bakelite ® EPH

The ring and ball method is the usual method for ascertaining the softening points. Details can be found in ASTM E 28 and DIN EN 1238, hereby expressly incorporated by reference.

The expansion capacity of the microballoons can be described via the determination of the TMA density [kg/m³] (Stare Thermal Analysis System from Mettler Toledo; heating rate 20° C./min). The TMA density here is the minimum attainable density for a defined temperature Tₘₐₓ under atmospheric pressure before the microballoons collapse.

### I. Preparation of PSA 1 to PSA 9

Described below is the preparation of the initial polymers. The synthetic rubber pressure-sensitive adhesive examples PSA 1 to PSA 6 were prepared in solution, coated onto a 23 μm etched PET film, and then dried. The coatweight was 50 g/m² in each case. The acrylate-based comparative example PSA 8 was prepared conventionally in solution via a free radical polymerization.

### Comparative Example

### Crosslinked Synthetic Rubber PSA (PSA 7)

For this comparative example PSA 7, PSA 1 was used, and after coating and drying is additionally crosslinked by means of electron beam curing (EBC). This electron beam curing was done using a unit from Electron Crosslinking AB (Halmstad, Sweden) and using an accelerator voltage of 220 keV and also a dose of 35 kGy with a belt speed of 3 m/min.

TABLE 1
Synthetic rubber PSAs 1 to 7 (wt % in each case)

| | | | | | | | Comparative |
|---|---|---|---|---|---|---|---|
| | | | | | Comparative | Comparative | Example |
| | 1 | 2 | 3 | 4 | Example 5 | Example 6 | 7^{a)} |
| Kraton D 1101 | 33.0 | — | 33.0 | 25.0 | 50.0 | — | 33.0 |
| Kraton D 1118 | 17.0 | 17.0 | — | 25.0 | — | — | 17.0 |
| Vector 4113 | — | 33.0 | — | — | — | — | — |
| Solprene 1205 | — | — | 17.0 | — | — | 50.0 | — |
| Escorez 2203 | 48.0 | 48.0 | 48.0 | — | 48.0 | 48.0 | 48.0 |
| Dercolyte A | — | — | — | 48.0 | — | — | — |
| 115 | | | | | | | |
| Wingtack 10 | — | — | — | 2.0 | — | — | — |
| Shellflex 371 | 2.0 | 2.0 | 2.0 | — | 2.0 | 2.0 | 2.0 |

^{a)}PSA 7 was EBC-crosslinked (accelerator voltage: 220 keV; dose: 35 kGy)

### Comparative Example

### Polyacrylate PSA (PSA 8)

A 100 L glass reactor conventional for radical polymerizations was charged with 2.0 kg of acrylic acid, 25.0 kg of butyl acrylate, 13.0 kg of 2-ethylhexyl acrylate and 26.7 kg of acetone/benzene 60/95 (1:1). After nitrogen gas had been passed through the reactor for 45 minutes with stirring, the reactor was heated up to 58° C. and 30 g of AIBN were added. After that the external heating bath was heated to 75° C. and the reaction was carried out constantly at this external temperature. After a reaction time of 1 hour a further 30 g of AIBN were added. After 4 hours and 8 hours, dilution took place with 10.0 kg of acetone/benzene 60/95 (1:1) mixture each time. For reduction of the residual initiators, 90 g portions of bis-(4-tert-butylcyclohexyl)peroxydicarbonate were added after 8 hours and again after 10 hours. The reaction was terminated after a time of 24 hours, and cooling took place to room temperature.

The polyacrylate was subsequently blended with 0.2 wt % of Uvacure® 1500, diluted to a solids content of 30% with acetone, and then coated from solution onto a siliconized release file (50 μm polyester) or onto a 23 μm, etched PET film. (Coating rate 2.5 m/min, drying tunnel 15 m, temperatures zone 1: 40° C., zone 2: 70° C., zone 3: 95° C., zone 4: 105° C.). The coatweight was 50 g/m².

### Comparative Example

### Resin-Modified Polyacrylate PSA (PSA 9)

The resin-modified polyacrylate PSA Aroset™ PS 5145 from Ashland (product number 371855, solution with solids content of around 60 wt %, ready-blended with aluminium acetylacetonate, CAS no. 13963-57-0, as crosslinker) was diluted to a solids content of 30% with acetone, and then coated from solution onto a siliconized release file (50 μm polyester) or onto a 23 μm, etched PET film. (Coating rate 2.5 m/min, drying tunnel 15 m, temperatures zone 1: 40° C., zone 2: 75° C., zone 3: 100° C., zone 4: 115° C.). The coatweight was 50 g/m².

TABLE 2
Technical adhesive data for PSAs 1 to 8, with a
coatweight of 50 g/m² on a 23 μm, etched PET film

| | Bond strength | Bond strength | | |
|---|---|---|---|---|
| | to steel | to PE | HP RT | HP 70° C. |
| | [N/cm] | [N/cm] | [min] | [min] |
| PSA 1 | 8.5 | 3.5 | >10,000 | >10,000 |
| PSA 2 | 10.9 | 6.4 | >10,000 | 3400 |
| PSA 3 | 9.4 | 4.1 | >10,000 | 7900 |
| PSA 4 | 9.2 | 4.8 | >10,000 | >10,000 |
| PSA 5 | 7.5 | 1.2 | 6000 (A) | 1200 (A) |
| PSA 6 | 10.4 | 5.5 | 4500 | 200 |
| PSA 7 | 3.8 | 0.5 | >10,000 | >10,000 |
| PSA 8 | 4.4 | 1.0 | >10,000 | >10,000 |
| PSA 9 | 13.0 | 4.5 | 3000 | 60 |

The bond strength measurements took place at an angle of 180° in accordance with Method H1.

The holding power HP was measured by Method H3. In the absence of any information on the fracture aspect, the failure of the PSA is cohesive. A: adhesive fracture

### II. Preparation of the Starting Polymers for the Viscoelastic Polyacrylate Foam Carriers VT 1 to VT 5

Described below is the preparation of the starting polymers. The polymers investigated are prepared conventionally in solution via a free radical polymerization.

### Base Polymer VT 1

A reactor conventional for radical polymerizations was charged with 27 kg of 2-ethylhexyl acrylate, 27 kg of n-butyl acrylate, 4.8 kg of methyl acrylate, 0.6 kg of acrylic acid, 0.6 kg of 2-hydroxyethyl methacrylate (HEMA) and 40 kg of acetone/isopropanol (93:7). After nitrogen gas had been passed through the reactor for 45 minutes, with stirring, the reactor was heated up to 58° C. and 30 g of AIBN were added. Thereafter the external heating bath was heated to 75° C. and the reaction was carried out constantly at this external temperature. After 1 hour a further 30 g of AIBN were added and after 4 hours dilution took place with 10 kg of acetone/isopropanol mixture.

After 5 hours and again after 7 hours, re-initiation was carried out with 90 g of bis(4-tert-butylcyclohexyl) peroxydicarbonate. After a reaction time of 22 hours the polymerization was discontinued and cooling took place to room temperature. The polyacrylate has a K value of 69, a solids content of 54.6%, an average molecular weight of M_{w}=819,000 g/mol, polydispersity (M_{w}/Mₙ)=7.6 and a static glass transition temperature of T_{g}=−37.7° C.

### Base Polymer VT 2

A reactor conventional for radical polymerizations was charged with 54.4 kg of 2-ethylhexyl acrylate, 20.0 kg of methyl acrylate, 5.6 kg of acrylic acid and 53.3 kg of acetone/isopropanol (94:6). After nitrogen gas had been passed through the reactor for 45 minutes, with stirring, the reactor was heated up to 58° C. and 40 g of 2,2′-azobis(2-methylbutyronitrile) were added. Thereafter the external heating bath was heated to 75° C. and the reaction was carried out constantly at this external temperature. After 1 hour a further 40 g of 2,2′-azobis(2-methylbutyronitrile) were added and after 4 hours dilution took place with 10 kg of acetone/isopropanol mixture (94:6).

After 5 hours and again after 7 hours, re-initiation was carried out with 120 g of bis(4-tert-butylcyclohexyl) peroxydicarbonate. After a reaction time of 22 hours the polymerization was discontinued and cooling took place to room temperature. The polyacrylate has a K value of 58.8, a solids content of 55.9%, an average molecular weight of M_{w}=746,000 g/mol, polydispersity (M_{w}/Mₙ)=8.9 and a static glass transition temperature of T_{g}=−35.6° C.

### Base Polymer VT 3

During the polymerization of VT 2, a further 10 wt % (based on polymer solids) of Aerosil R 972 was used.

The polyacrylate has a K value of 58.8, a solids content of 58.2%, an average molecular weight of M_{w}=746,000 g/mol, polydispersity (M_{w}/Mₙ)=8.9 and a static glass transition temperature of T_{g}=−35.4° C.

### Base Polymer VT 4

A reactor conventional for radical polymerizations was charged with 24.0 kg of 2-ethylhexyl acrylate, 53.6 kg of methyl acrylate, 2.4 kg of acrylic acid and 53.3 kg of acetone/isopropanol (96:4). After nitrogen gas had been passed through the reactor for 45 minutes, with stirring, the reactor was heated up to 58° C. and 40 g of AIBN were added. Thereafter the external heating bath was heated to 75° C. and the reaction was carried out constantly at this external temperature. After 1 hour a further 40 g of AIBN were added and after 4 hours dilution took place with 10 kg of acetone/isopropanol mixture (96:4).

After 5 hours and again after 7 hours, re-initiation was carried out with 120 g of bis(4-tert-butylcyclohexyl) peroxydicarbonate. After a reaction time of 22 hours the polymerization was discontinued and cooling took place to room temperature. The polyacrylate has a K value of 77.8, a solids content of 55.9%, an average molecular weight of M_{w}=1,040,000 g/mol, polydispersity (M_{w}/Mₙ)=13.3 and a static glass transition temperature of T_{g}=−45.1° C.

### Base Polymer VT 5

A reactor conventional for radical polymerizations was charged with 30 kg of 2-ethylhexyl acrylate, 67 kg of n-butyl acrylate, 3 kg of acrylic acid and 66 kg of acetone/isopropanol (96:4). After nitrogen gas had been passed through the reactor for 45 minutes, with stirring, the reactor was heated up to 58° C. and 50 g of 2,2′-azobis(2-methylbutyronitrile) were added. Thereafter the external heating bath was heated to 75° C. and the reaction was carried out constantly at this external temperature. After 1 hour a further 50 g of 2,2′-azobis(2-methylbutyronitrile) were added and after 4 hours dilution took place with 20 kg of acetone/isopropanol mixture (96:4).

After 5 hours and again after 7 hours, re-initiation was carried out with 150 g of bis(4-tert-butylcyclohexyl) peroxydicarbonate, and dilution with 23 kg of acetone/isopropanol mixture (96:4). After a reaction time of 22 hours the polymerization was discontinued and cooling took place to room temperature. The polyacrylate has a K value of 75.1, a solids content of 50.2%, an average molecular weight of M_{w}=1,480,000 g/mol, polydispersity (M_{w}/Mₙ)=16.1 and a static glass transition temperature of T_{g}=−38.5° C.

### III Production of Microballoon Mixtures

The microballoons are placed in a container which has been charged with Reofos® RDP as liquid component (dispersant) as reported in the individual examples. Stirring takes place in a planetary stirrer mechanism from PC-LABORSYSTEM under a pressure of 5 mbar with a rotary speed of 600 rpm for 30 minutes.

### Process 1: Concentration/Preparation of the Polyacrylate Hotmelts

The acrylate copolymers (base polymers VT 1 to VT 5) are very largely freed from the solvent by means of a single-screw extruder (concentrating extruder, Berstorff GmbH, Germany) (residual solvent content 0.3 wt %; cf. the individual examples). The parameters given here by way of example are those for the concentration of base polymer VT 1. The screw speed was 150 rpm, the motor current 15 A, and a throughput of 60.0 kg liquid/h was realized. For concentration, a vacuum was applied at three different domes. The reduced pressures were, respectively, between 20 mbar and 300 mbar. The exit temperature of the concentrated hotmelt is approximately 115° C. The solids content after this concentration step was 99.8%.

### Process 2: Preparation of Foamed Composition

Foaming takes place in an experimental unit which corresponds to the illustration in FIG. 2.

The corresponding base polymer K (VT 1 to VT 5) is melted in a feeder extruder 1 (single-screw conveying extruder from Troester GmbH & Co. KG, Germany) and is conveyed by this extruder, in the form of a polymer melt, via a heatable hose 11 into a planetary roller extruder 2 (PRE) from Entex (Bochum) (more particularly a PRE with four modules heatable independently of one another, T₁, T₂, T₃ and T₄, was used). Via the metering port 22, the melted resin is then added. In addition, there exists the possibility of supplying additional additives or fillers, such as colour pastes, for example, via further metering points that are present. At point 23, the crosslinker is added. All of the components are mixed to form a homogeneous polymer melt.

By means of a melt pump 24a and a heatable hose 24b, the polymer melt is transferred into a twin-screw extruder 3 (from Berstorff) (feed position 33). At position 34, the accelerator component is added. Subsequently the mixture as a whole is freed from all of the gas inclusions in a vacuum dome V at a pressure of 175 mbar (for the criterion for freedom from gas, see above). Downstream of the vacuum zone, on the screw, there is a blister B, which allows a build-up of pressure in the subsequent segment S. Through appropriate control of the extruder speed and of the melt pump 37a, a pressure of greater than 8 bar is built up in the segment S between blister B and melt pump 37a, and at the metering point 35 the microballoon mixture (microballoons embedded into the dispersing assistant in accordance with the details given for the experimental series) is added, and is incorporated homogeneously into the premix by means of a mixing element. The resultant melt mixture is transferred into a die 5.

Following departure from the die 5, in other words after a drop in pressure, the incorporated microballoons undergo expansion, and the drop in pressure results in a low-shear, more particularly no-shear, cooling of the polymer composition. This produces a foamed self-adhesive composition S, which subsequently is coated between two release materials, more particularly between a release material which can be used again after being removed (in-process liner), and is shaped to a web by means of a roll calendar 4.

TABLE 3
Viscoelastic polyacrylate foam carriers VT 1 to VT 5

| Example | | | | VT 1 | VT 2 | VT 3 | VT 4 | VT 5 |
|---|---|---|---|---|---|---|---|---|
| Components | Polyacrylate | | [wt %] | 97.4 | 63.1 | 97.0 | 97.0 | 97.1 |
| | Dertophene T110 | | | — | 31.0 | — | — | — |
| | Expancel 051 DU 40 | | | 2.0 | 2.0 | 2.0 | 2.0 | 2.0 |
| | Polypox R16 | | | 0.143 | 0.139 | 0.149 | 0.139 | 0.222 |
| | Jeffcat ZF-10 | | | 0.140 | — | — | — | — |
| | Epikure 925 | | | — | 0.144 | — | 0.144 | 0.144 |
| | Jeffcat Z-130 | | | — | — | 0.165 | — | — |
| | Reofos RDP | | | 0.66 | 0.66 | 0.66 | 0.66 | 0.48 |
| Construction | Thickness | | [μm] | 1091 | 1109 | 1123 | 1130 | 1134 |
| | Density (I.2) | | kg/m³] | 770 | 753 | 744 | 752 | 680 |
| Performance | HP [min] | RT 20N | [min] | 1016 | 1275 | 1753 | 3309 | 3147 |
| | | 70° C. 10N | | 20 | 28 | 39 | 31 | 2954 |
| | Bond strength for | immediate | [N/cm] | 18.3 A | 24.5 A | 31.0 A | 36.5 A | 21.0 A |
| | steel | 3 d | | 30.6 A | 33.4 A | 43.1 A | 48.2 A | 64.3 K |
| | [N/cm] | 14 d | | 29.9 A | 35.1 A | 42.7 A | 49.2 A | 65.2 K |

Density: Method A5a, bond strength: Method H2 (A denotes adhesive fracture; K denotes cohesive fracture), HP (holding power): Method H4
Epikure ® also sold under the commercial designations Epi-Cure ® and Bakelite ® EPH

### IV Three-Layer Pressure-Sensitive Adhesive Tape Products MT 1 to C-MT 26

Unless indicated further, both sides of the viscoelastic carrier were coated with the same PSA. The coatweight of the respective PSA layer on the viscoelastic carrier is in all cases 50 g/m².

In order to improve the anchoring of the PSA on the shaped, viscoelastic carrier layer, not only the PSA but also the viscoelastic carrier are corona-treated prior to the laminating step (corona unit from Vitaphone, Denmark, 100 W·min/m²). After the three-layer assembly has been produced, this treatment leads to improved chemical attachment to the viscoelastic carrier layer. The web speed when travelling through the laminating unit is 30 m/min. Prior to lamination, any anti-adhesive support, more particularly an in-process liner, is removed, and the completed three-layer product is wound up together with a remaining, second anti-adhesive support.

Presented below are specific examples of the inventive adhesive tapes (MT) and also non-inventive adhesive tapes (C-MT), without any intention to impose unnecessary restriction on the invention by the choice of the specified formulations, configurations, operational parameters and/or product designs.

TABLE 4
Examples MT 1 to MT 10 (variation in the viscoelastic polyacrylate foam carrier layer)

| | | | | | BS to | HP 10 N, | HP 10 N, | Dyn. shear |
|---|---|---|---|---|---|---|---|---|
| | | Viscoel. | BS to steel | BS to PE | varnish | RT | 70° C. | strength |
| Ex. | PSA | carrier | [N/cm] | [N/cm] | [N/cm] | [min] | [min] | [N/cm²] |
| MT 1 | PSA 1 | VT 1 | 50 f.s. | 19 | 48 f.s. | >10,000 | >10,000 | 60 |
| MT 2 | PSA 1 | VT 2 | 50 f.s. | 23 | 48 f.s. | >10,000 | 1200 | 63 |
| MT 3 | PSA 1 | VT 3 | 42 | 17 | 42 | >10,000 | >10,000 | 44 |
| MT 4 | PSA 1 | VT 4 | 50 f.s. | 25 | 48 f.s. | >10,000 | 5200 | 54 |
| MT 5 | PSA 1 | VT 5 | 50 f.s. | 23 | 48 f.s. | >10,000 | >10,000 | 65 |
| MT 6 | PSA 2 | VT 1 | 50 f.s. | 18 | 45 | >10,000 | >10,000 | 48 |
| MT 7 | PSA 2 | VT 2 | 42 | 19 | 41 | >10,000 | 1100 | 60 |
| MT 8 | PSA 2 | VT 3 | 39 | 16 | 42 | >10,000 | >10,000 | 44 |
| MT 9 | PSA 2 | VT 4 | 50 f.s. | 24 | 48 f.s. | >10,000 | 5500 | 52 |
| MT 10 | PSA 2 | VT 5 | 50 f.s. | 24 | 48 f.s. | >10,000 | >10,000 | 65 |

Bond strength (BS): Method H2, HP (holding power): Method H4, dynamic shear strength: Method H5
f.s.: foam split (cohesive splitting of the viscoelastic carrier)

TABLE 5
Examples MT 11 to C-MT 26 (variation in PSA; C-MT are non-inventive, comparative examples)

| | | | | | BS to | HP 10 N, | HP 10 N, | Dyn. shear |
|---|---|---|---|---|---|---|---|---|
| | | Viscoel. | BS to steel | BS to PE | varnish | RT | 70° C. | strength |
| Ex. | PSA | carrier | [N/cm] | [N/cm] | [N/cm] | [min] | [min] | [N/cm²] |
| MT 1 | PSA 1 | VT 1 | 50 f.s. | 19 | 48 f.s. | >10,000 | >10,000 | 60 |
| MT 6 | PSA 2 | VT 1 | 50 f.s. | 18 | 45 | >10,000 | >10,000 | 48 |
| MT 11 | PSA 3 | VT 1 | 50 f.s. | 22 | 48 f.s. | >10,000 | >10,000 | 60 |
| MT 12 | PSA 4 | VT 1 | 50 f.s. | 21 | 46 | >10,000 | >10,000 | 61 |
| C-MT 13 | PSA 5 | VT 1 | 40 | 14 | 28 | 4500 (A) | 1100 (A) | 44 |
| C-MT 14 | PSA 6 | VT 1 | 50 f.s. | 22 | 44 | 8500 | 200 | 62 |
| C-MT 15 | PSA 7 | VT 1 | 41 | 13 | 41 | 7500 (A) | 380 (A) | 55 |
| C-MT 16 | PSA 8 | VT 1 | 25 | 3 | 13 | >10,000 | 2000 | 41 |
| C-MT 17 | PSA 9 | VT 1 | 45 | 11 | 27 | 8200 | 190 | 62 |
| MT 5 | PSA 1 | VT 5 | 50 f.s. | 23 | 48 f.s. | >10,000 | >10,000 | 65 |
| MT 10 | PSA 2 | VT 5 | 50 f.s. | 24 | 48 f.s. | >10,000 | >10,000 | 65 |
| MT 18 | PSA 3 | VT 5 | 50 f.s. | 22 | 46 | >10,000 | >10,000 | 62 |
| MT 19 | PSA 4 | VT 5 | 50 f.s. | 21 | 48 f.s. | >10,000 | >10,000 | 63 |
| C-MT 20 | PSA 5 | VT 5 | 38 | 17 | 32 | >10,000 | >10,000 | 45 |
| C-MT 21 | PSA 6 | VT 5 | 50 f.s. | 22 | 42 | 8500 | 200 | 62 |
| C-MT 22 | PSA 7 | VT 5 | 48 | 16 | 43 | 6200 (A) | 150 (A) | 63 |
| C-MT 23 | PSA 8 | VT 5 | 23 | 2 | 13 | >10,000 | 2000 | 40 |
| C-MT 24 | PSA 9 | VT 2 | 44 | 11 | 30 | 8200 | 320 | 58 |
| C-MT 25 | PSA 9 | VT 5 | 42 | 3 | 30 | 2000 | 0 | 42 |

| | | | | | | | |
|---|---|---|---|---|---|---|---|
| C-MT 26^{a)} | lined side (JL-2) | 46 | 6 | 45 | 3000 | 90 | 60 |

Bond strength (BS): Method H2, HP (holding power): Method H4, dynamic shear strength: Method H5. In the absence of indications of the fracture pattern, the failure of the PSA is cohesive. A: adhesive fracture f.s.: foam split (cohesive splitting of the viscoelastic carrier)
^{a)}Example C-MT 26 is the product EX 4011 from the Acrylic Plus Tape Series from 3M ™. This is a double-sided adhesive tape with a viscoelastic polyacrylate foam carrier and two different outer PSA layers. The PSA JL-2 of the lined side, whose technical adhesive data are set out in Table 5, is praised in particular for non-polar surfaces and also for automotive paints and powder coatings.
As may be inferred from the comparative examples, the majority of PSAs do not have sufficient holding power. Comparative Example C-MT 20 fails because adhesive fracture rather than foam split is observed. For such fracture there is no model; it is chaotic and unmodellable. The skilled person avoids adhesives which exhibit adhesive fracture, owing to the unpredictable behaviour.

TABLE 6
Peel increase

| | Bond strength | Bond | Bond | Bond |
|---|---|---|---|---|
| | to steel, | strength to | strength to | strength to |
| | immediate | steel, 20 min | steel, 1 d | steel, 3 d |
| Ex. | [N/cm] | [N/cm] | [N/cm] | [N/cm] |
| PSA 1^{a)} | 13 | 13 | 14 | 15 |
| VT 5^{a)} | 7 | 8 | 10 | 13 |
| MT 5 | 50 f.s. | 50 f.s. | 50 f.s. | 50 f.s. |
| C-MT 22 | 48 | 48 | 48 | 50 f.s. |
| C-MT 23 | 23 | 23 | 30 | 48 |
| C-MT 26 | 45 | 46 f.s. | 46 f.s. | 46 f.s. |

^{a)}Layer thickness: 50 μm
immediate: <1 minute, f.s.: foam split

From Table 6 it can be seen that only the combination of the adhesives of the invention with the viscoelastic carrier produces a foamed adhesive tape which meets the requirements for very high immediate bond strengths in combination with carrier splitting (foam split). The comparative examples, in contrast, show a marked peel increase, with carrier splitting achievable not until after a longer time—carrier splitting is desirable for more reliable prediction of adhesive bonds.

V Three-Layer Pressure-Sensitive Adhesive Tape Products MT 27 with Asymmetric Product Construction

The construction of Example MT 27 is as follows:

Viscoelastic polyacrylate foam carrier:
VT 5 (thickness: 900 μm; density: 680 kg/m³; carbon black was added to formula VT 5 to colour the product black)
PSA on lined side:
PSA 1 (50 g/m²)
PSA on open side:
PSA 8 (50 g/m²)

### Liner:

Version I): blue polyethylene liner, coated on one side with silicone, suitable for high-temperature applications following application of the open side
Version II): blue, silicone-free polyethylene liner

| | BS to | | BS to | HP 10 N | HP 10 N | Dyn. shear |
|---|---|---|---|---|---|---|
| | steel | BS to PE | varnish | RT | 70° C. | strength |
| Side | [N/cm] | [N/cm] | [N/cm] | [min] | [min] | [N/cm²] |
| open | 22 | 2 | 13 | >10 000 | 2000 | 41 |
| lined | 50 f.s. | 23 | 48 f.s. | >10 000 | >10 000 | 64 |

1. Adhesive tape, with a carrier material, comprising an acrylate-based foam layer bearing at least one layer of pressure-sensitive adhesive, the pressure-sensitive adhesive
(a) being composed of a mixture of at least two different synthetic rubbers;
(b) comprising a resin that is not soluble in the acrylates forming the foam layer; and
(c) being chemically uncrosslinked.

2. Adhesive tape according to claim 1, wherein the foam layer is a viscoelastic foam layer.

3. Adhesive tape according to claim 1, wherein the acrylate forming the foam layer is a polyacrylate obtained by free or controlled radical polymerization of one or more acrylates and alkylacrylates.

4. Adhesive tape according to claim 1, wherein the acrylate forming the foam layer is a thermally crosslinked polyacrylate.

5. Adhesive tape according to at least one of claim 1, wherein the acrylate forming the foam layer is a poly(meth)acrylate comprising
(a1)) 70 to 100 wt % of acrylic esters and/or methacrylic esters and/or the free acids thereof, of the following structural formula 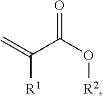
where R¹ is H or CH₃ and R² is H or alkyl chains having 1 to 14 C atoms,
(a2) 0 to 30 wt % of olefinically unsaturated monomers having functional groups, and
(a3) optionally, further acrylates and/or methacrylates and/or olefinically unsaturated monomers, with a fraction between 0 to 5 wt %, which are copolymerizable with component (a1)) and have a functional group which by means of the coupling reagent leads to covalent crosslinking.

6. Adhesive tape according to claim 4, wherein use is made
as monomers (a1) of acrylic monomers comprising acrylic and methacrylic esters with alkyl groups consisting of 1 to 14 C atoms, selected from the group consisting of methyl acrylate, methyl methacrylate, ethyl acrylate, ethyl methacrylate, propyl acrylate, propyl methacrylate, n-butyl acrylate, n-butyl methacrylate, n-pentyl acrylate, n-hexyl acrylate, n-hexyl methacrylate, n-heptyl acrylate, n-octyl acrylate, n-nonyl acrylate, lauryl acrylate, stearyl acrylate, stearyl methacrylate, behenyl acrylate and branched isomers thereof;
as monomers (a2) of maleic anhydride, itaconic anhydride, glycidyl methacrylate, benzyl acrylate, benzyl methacrylate, phenyl acrylate, phenyl methacrylate, tert-butylphenyl acrylate, tert-butylphenyl methacrylate, phenoxyethyl acrylate, phenoxyethyl methacrylate, 2-butoxyethyl methacrylate, 2-butoxyethyl acrylate, dimethylaminoethyl methacrylate, dimethylaminoethyl acrylate, diethylaminoethyl methacrylate, diethylaminoethyl acrylate and tetrahydrofurfuryl acrylate; and/or
as monomers (a3) of hydroxyethyl acrylate, 3-hydroxypropyl acrylate, hydroxyethyl methacrylate, 3-hydroxypropyl methacrylate, 4-hydroxybutyl acrylate, 4-hydroxybutyl methacrylate, allyl alcohol, itaconic acid, acrylamide and cyanoethyl methacrylate, cyanoethyl acrylate, 6-hydroxyhexyl methacrylate, N-tert-butylacrylamide, N-methylolmethacrylamide, N-(butoxymethyl)methacrylamide, N-methylolacrylamide, N-(ethoxymethyl)acrylamide, N-isopropylacrylamide, vinylacetic acid, β-acryloyloxypropionic acid, trichloroacrylic acid, fumaric acid, crotonic acid, aconitic acid, dimethylacrylic acid and 4-vinylbenzoic acid.

7. Adhesive tape according to claim 5, wherein the comonomers are selected such that the glass transition temperature T_{g,A} of the polymers is below the application temperature.

8. Adhesive tape according to claim 1, wherein the acrylate-based foam layer is admixed with at least one tackifying resin.

9. Adhesive tape according to claim 1, wherein the acrylate-based foam layer is foamed using microballoons.

10. Adhesive tape according to claim 1, wherein the acrylate-based foam layer is crosslinked.

11. Adhesive tape according to claim 1, wherein the acrylate-based foam layer has a layer thickness of between 0.3 mm and 5 mm.

12. Adhesive tape according to claim 1, wherein the pressure-sensitive adhesive comprises to an extent of at least 70 wt % a mixture of
(i) block copolymers comprising a mixture of block copolymers with the structures I and II
I) A′-B′
II) A-B-A, (A-B)ₙ, (A-B)ₙX and/or (A-B)ₙX, where
X is the radical of a coupling reagent,
n is an integer between 2 and 10,
A and A′ is a polymer block of a vinylaromatic,
B and B′ is a polymer block formed from butadiene, a mixture of butadiene and isoprene and/or a mixture of butadiene and styrene, and
A and A′, and B and B′, may be identical or different,
(ii) at least one tackifier resin,
the fraction of the block copolymers I) being between 30 and 70 wt %, based on the total amount of block copolymers,
the fraction A in the case of the block copolymers II) being between 25 and 40 wt %,
and the A-B unit within at least one of the vinylaromatic block copolymers of the structure II having a molecular weight M_{w} of greater than 65 000 g/mol, the molecular weight M_{w} of the total block copolymer II being greater than 130 000 g/mol.

13. Adhesive tape according to claim 12, wherein the pressure-sensitive adhesive comprises as elastomers only a mixture of vinylaromatic block copolymers of structures I and II, it being possible for the mixture to consist of a vinylaromatic block copolymer of the structure I and a vinylaromatic block copolymer of the structure II or for the mixture to consist of a plurality of different vinylaromatic block copolymers of the structures I and II.

14. Adhesive tape according to claim 12, wherein, in addition to the structures I and II, a block copolymer is used which is a multi-arm block copolymer described by the general formula Qₙ-Y.

15. Adhesive tape according to claim 12, wherein the block A is a glasslike block having a glass transition temperature (T_{g}) above at least 40° C.

16. Adhesive tape according to at least one of claim 12, wherein the block B is rubberlike or is a soft block having a T_{g} of less than room temperature.

17. Adhesive tape according to claim 12, wherein a fraction of the vinylaromatic block copolymer or of the vinylaromatic block copolymers of the structure I in the sum total of the vinylaromatic block copolymers of the structures I and II is between 30 and 70 wt %.

18. Adhesive tape according to claim 12, wherein a fraction or fractions of the vinylaromatic end block A in the block copolymer of the structure I, and/or the fraction or fractions of the vinylaromatic end blocks A and A′ in the block copolymer of the structure II, is or are between 20 and 40 wt %.

19. Adhesive tape according to claim 12, wherein the pressure-sensitive adhesive comprises a first resin having a T_{g} of at least 60° C., which is compatible with the elastomer blocks of the block copolymers, and/or comprises a second resin having a T_{g} of less than 60° C., which is compatible with the glasslike blocks of the linear block copolymers and/or of the multi-arm block copolymers.

20. Adhesive tape according to claim 12, wherein the pressure-sensitive adhesive comprises endblock reinforcer α-methylstyrene resins.

21. Adhesive tape according to claim 12, wherein the layer of pressure-sensitive adhesive is applied with a weight per unit area of 40 to 100 g/m² on the viscoelastic foam carrier layer.

22. Adhesive tape according to claim 12, wherein the adhesive tape consists of the viscoelastic foam carrier layer, that bears a layer of pressure-sensitive adhesive on one side.

23. Adhesive tape according to claim 1, wherein the adhesive tape has a thickness between 100 μm to 5000 mm.

24. Method for producing an adhesive tape according to claim 1, the method comprising:
(i) producing a viscoelastic foam carrier layer having a top face and a bottom face, by
(a) providing a mixture which is polymerizable by means of free or controlled radical polymerization and comprises one or more acrylate and alkylacrylate monomers,
(b) polymerizing the mixture specified under (a),
(c) carrying out thermal crosslinking, and
(d) foaming the polyacrylate, and
(ii) application by coating of one or more pressure-sensitive adhesives, of which at least one
(a) is chemically uncrosslinked and
(b) comprises a mixture of synthetic rubbers,
to at least one of the principal sides of said acrylate foam carrier, in order thus to produce a layer of pressure-sensitive adhesive.

25. Method for producing an adhesive tape according to claim 1, the method comprising:
(i) producing a viscoelastic foam carrier layer having a top face and a bottom face, by
(a) providing a mixture which is polymerizable by means of free or controlled radical polymerization and comprises one or more acrylate and alkylacrylate monomers,
(b) polymerizing the mixture specified under (a),
(c) removing the solvent,
(d) processing the polyacrylate in the melt
(e) in said melt, compounding and homogenizing chemical and/or physical blowing agents and thermal crosslinkers in an extruder,
(f) carrying out thermal crosslinking, and
(g) foaming the polyacrylate, and
(ii) application by coating of one or more pressure-sensitive adhesives, of which at least one in accordance with the invention
(a) is chemically uncrosslinked and
(b) comprises a mixture of vinylaromatic block copolymers, and also
(c) comprises resins which are not soluble in a polyacrylate and
therefore are unable to migrate into the acrylate foam carrier layer, to at least one of the principal sides of said acrylate foam carrier, in order thus to produce a layer of pressure-sensitive adhesive.

26-27. (canceled)
